(19) United States
(12) Patent Application Publication
(10) Pub. No.: US 2025/0073713 A1
(43) Pub. Date: Mar. 6, 2025

(54) MICROCHANNEL SEPARATOR AND METHODS FOR MAKING AND USING THE SAME

(71) Applicants: Oregon State University, Corvallis, OR (US); University of Pittsburgh - Of the Commonwealth System of Higher Education, Pittsburgh, PA (US)

(72) Inventors: Goran Jovanovic, Corvallis, OR (US); Francis Chukwunta, Corvallis, OR (US); Matthew Coblyn, Corvallis, OR (US); Lucas Freiberg, Corvallis, OR (US); Jad Touma, Seattle, WA (US); Aigerim Baimoldina, Pittsburgh, PA (US); Lei Li, Pittsburgh, PA (US); Yihan Song, Pittsburgh, PA (US); Bingchen Wang, Pittsburgh, PA (US); Fan Yang, Pittsburgh, PA (US)

(73) Assignees: Oregon State University, Corvallis, OR (US); University of Pittsburgh - Of the Commonwealth System of Higher Education, Pittsburgh, PA (US)

(21) Appl. No.: 18/821,406

(22) Filed: Aug. 30, 2024

Related U.S. Application Data
(60) Provisional application No. 63/580,299, filed on Sep. 1, 2023.

(51) Int. Cl. B01L 3/00

(52) U.S. Cl. CPC B01L 3/502769; B01L 2300/0838; B01L 2300/161; B01L 2400/0406

(57) ABSTRACT

This disclosure is directed to devices for the separation of mixtures of fluid phases. In some aspects of the disclosure, the separation device comprises an angled capillary cell. In other aspects, the separation device comprises a plurality of angled capillary cells operating in parallel. In some aspects of the disclosure, the separation device may be monolithically formed by an additive manufacturing process, such as three-dimensional printing. In some aspects of the disclosure, the separation device may function independently of gravitational direction, and without the use of filters.

### CROSS REFERENCE TO RELATED APPLICATION

This application claims the benefit of U.S. Provisional Patent Application No. 63/580,299, filed Sep. 1, 2023, which is incorporated herein by reference in its entirety.

### ACKNOWLEDGEMENT OF GOVERNMENT SUPPORT

This invention was made with government support under DE-EE0007888 and DE-EE0009436 awarded by the United States Department of Energy. The government has certain rights in the invention.

### FIELD

This disclosure relates to devices for separating mixtures of fluid phases via capillary action, and methods of using the same.

### BACKGROUND

The separation of mixtures of fluid phases, particularly liquid-liquid and gas-liquid extraction, is relevant to many industrial chemical and biochemical processes, including fuels production, pharmaceuticals, and hydrometallurgy. Many solvent extraction processes, however, are reliant on costly and bulky equipment which requires considerable investment. Furthermore, this equipment may rely on gravitational forces, membranes, or other components that impose restrictions on the use of these technologies and may be impractical in situations where rapid design and implementation is required. Therefore, to reduce the costs associated with the separation of fluid phases, to improve the reliability of this process, and to allow this process to be conducted on a more flexible basis, more robust and readily designed and manufactured devices capable of achieving high throughput through parallel operation are needed in the field of fluid separations.

### SUMMARY

Disclosed herein are devices for the physical separation of fluid mixtures that form separate phases (that is, immiscible or nearly immiscible fluids), such as mixtures of aqueous and organic fluids, mixtures of gas and liquid phases, mixtures of metallic brines, and/or ionic liquids. These devices may comprise one or more capillary channels that separate insoluble fluid phases that may wet the walls of the one or more capillary channels differently. Such capillary pressure can cause phases with different contact angles with the channels to physically separate as a mixture of such phases passes through the one or more channels. Also disclosed herein are methods for using the devices for fluid phase separation. Such methods may include passing the mixture of fluids through any one of the devices disclosed herein, using more than one phase separation device in series, and/or using more than one phase separation device in parallel. Separated fluid phases can be collected, further separated using one or more downstream devices, and/or mixed with other fluid phase streams. Furthermore, besides solvent extraction, these devices can perform similar unit operations such as stripping or washing.

Certain examples concern a fluid phase separator, comprising one or more capillary cells, each capillary cell comprising a first plate, a corresponding second plate spaced apart from the first plate, and a gap between the first plate and the second plate. The fluid phase separator also comprises an inlet in fluid communication with a first end of the one or more capillary cells, a first outlet in fluid communication with a second end of the one or more capillary cells, and a second outlet in fluid communication with the second end of the one or more capillary cells. Each first plate is disposed at an angle to the corresponding second plate, such that a distance between each first plate and the corresponding second plate is greater at a first side of each capillary cell than at a second side of each capillary cell. The fluid phase separator is configured to admit a first mixture of at least a first fluid and a second fluid at a first concentration, split the first mixture into (i) a second mixture of the first fluid and the second fluid at a second concentration and (ii) a third mixture of the first fluid and the second fluid at a third concentration, and emit the second mixture and the third mixture from the first outlet and the second outlet respectively.

Certain examples concern an array of phase separators, comprising a first phase separator, comprising a flow plate, a cover plate, a first inlet, a first outlet, and a second outlet, and an array of columns formed on the flow plate and disposed between the first inlet and the first outlet and the second outlet. The array of phase separators also comprises a second phase separator in fluid communication with the first phase separator, the second phase separator comprising a second inlet, a third outlet, a fourth outlet, and an array of capillary cells circumferentially arranged around a centerline axis and positioned between the second inlet and the third and fourth outlets. Each capillary cell of the second phase separator comprises a first interior surface, a second interior surface oriented at an angle relative to the first interior surface, and a gap positioned between the first interior surface and the second interior surface. The first phase separator is configured to receive a first fluid mixture with a first composition and produce a first product stream with a second composition and a second product stream with a third composition. The second phase separator is configured to receive a second fluid mixture with a fourth composition and produce third product stream with a fifth composition and a fourth product stream with a sixth composition.

Certain examples concern a fluid phase separator comprising a cylindrical body having an external wall, an inlet end, an outlet end, a central column extending between the inlet end and the outlet end along a longitudinal axis, and an internal cavity defined by the external wall and the central column. The fluid phase separator also comprises a plurality of vanes circumferentially disposed around the central column, extending between the inlet end and the outlet end, and extending from the central column to an interior surface of the external wall. The fluid phase separator also comprises a fluid inlet positioned at the inlet end, and a first fluid outlet and a second fluid outlet positioned at the outlet end of the cylindrical body. The plurality of vanes divides the internal cavity into a radially and axially extending plurality of capillary cells. The plurality of capillary cells is configured to at least partially separate a mixture of two or more fluid phases.

Certain examples concern an assembly, comprising a first fluid phase separator according to any aspect disclose herein and a second fluid phase separator according to any aspect disclosed herein.

Certain examples concern a fluid phase separator, comprising a first plate a second plate spaced apart from the first plate to define a channel extending between the first plate and the second plate a fixed housing that receives the first plate and the second plate, and defines an inlet and an outlet of the channel. The first plate and the second plate are oriented at a first angle relative to one another, such that a distance between the first plate and the second plate is greater at a first side of the channel than the distance between the first plate and the second plate at a second side of the channel. When a mixture of insoluble fluids passes through the channel from the inlet to the outlet, the mixture of insoluble fluids is separated into a first fluid with a first composition and a second fluid with a second composition.

Certain examples concern a method of separating two or more fluid phases, comprising: introducing a mixture comprising two or more fluid phases to any fluid phase separator, assembly, or array of fluid phase separators according to any aspect herein. The method also comprises passing the mixture through a capillary cell of the fluid phase separator, assembly, or array of fluid phase separators with a narrow side portion and a wide side portion and providing a variable angle of contact with the fluid, separating a first fluid phase of the two or more fluid phases having the highest contact angle with the capillary cell towards the wide side portion of the capillary cell by capillary motion, and separating the fluid phases with lower contact angles with the capillary cell than the first fluid phase towards the narrow side portion of the capillary cell. The method also comprises collecting the first fluid phase and collecting the remaining fluid phases separately from the first fluid phase.

Certain examples concern an assembly comprising: a coiled flow inverter, and any fluid phase separator, assembly, or array of fluid phase separators according to any aspect herein, positioned downstream of and in fluid communication with the coiled flow inverter.

The foregoing and other objects, features, and advantages of the present disclosure will become more apparent from the following detailed description, which proceeds with reference to the accompanying figures.

### BRIEF DESCRIPTION OF THE DRAWINGS

FIG. 1A is an exploded view of a capillary-based fluid phase separator according to one aspect of the present disclosure.

FIG. 1B is a top perspective view of the fluid phase separator of FIG. 1A.

FIG. 1C is a cross sectional view of the fluid phase separator of FIG. 1A.

FIG. 2A is a top-down cross-sectional view of a fluid phase separator and magnified view of the separator channels according to another aspect of the present disclosure.

FIG. 2B is a side cross sectional view of the fluid phase separator of FIG. 2A.

FIG. 3A is a side view of a fluid phase separator according to another aspect of the present disclosure.

FIG. 3B is a top-down cross-sectional view of the fluid phase separator of FIG. 3A.

FIG. 3C is an exploded view of the fluid phase separator of FIG. 3A.

FIG. 3D is a horizontal cross-sectional view of the fluid phase separator of FIG. 3A.

FIG. 4 is an illustration of the outlet spacing of an exemplary angled capillary separation channel.

FIG. 5 is top-down view of a fluid phase separator according to another aspect of the present disclosure.

FIG. 6 is a graph plotting the capillary pressure in a sloped microchannel as a function of channel depth, and an illustration of the differing pressures on a non-wetting droplet.

FIG. 7 is an illustration of various forms of fluid phase separation possible as a mixture of insoluble fluids begins to separate.

FIG. 8 illustrates a fluid phase mixer and fluid phase separator according to one aspect of the present disclosure.

FIG. 9 is a schematic of the 3-dimensional printing of the fluid phase separator of FIG. 8.

FIGS. 10A-10B are charts of extraction efficiency of lithium relative to that of other metals as a function of volumetric flow rate for various metal species.

FIGS. 11A-11B are charts of extraction efficiency relative to equilibrium values as a function of volumetric flow rate for various metal species.

FIGS. 12A-12B are charts of the separation factor for lithium versus other metal species as a function of volumetric flow rates.

FIG. 13 illustrates fluid mixture behavior in an experimental design according to one aspect.

FIG. 14A is a chart of the pressure drop across an evaluative test system as a function of volumetric flow rate according to one aspect of the present disclosure.

FIG. 14B is a chart of the power input as a function of volumetric flow rate according to one aspect of the present disclosure.

FIG. 15 is a chart of phase separation, expressed in percentage, as a function of flow rate, measured in a phase separator system according to one aspect of the present disclosure.

FIGS. 16A-16D show the hydrodynamic pressure drop in a sloped capillary channel according to some aspects of the present disclosure.

FIG. 17 shows the additive manufacturing of a fluid phase separator according to one aspect of the present disclosure.

FIG. 18 illustrates fluid phase separators of varying lengths according to one or more aspects of the present disclosure.

FIG. 19 is a chart of the purity, expressed as a percentage, of the output purity of an aqueous-organic mixed fluid phase according to one aspect of the present disclosure.

FIG. 20 illustrates a system for the separation of an industrial waste fluid, according to one aspect of the present disclosure.

FIG. 21 is a chart showing the output purity of the system of FIG. 20 over the duration of a 100-hour separation study.

### DETAILED DESCRIPTION

### I. Definition of Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly indicates otherwise. The term “or” refers to a single element of stated alternative elements or a combination of two or more elements unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods, as known to those persons of ordinary skill in the art. When directly and explicitly distinguishing embodiments from discussed prior art, the embodiment numbers are not approximates unless the word “about” is recited.

Although the operations of some of the disclosed embodiments are described in a particular, sequential order for convenient presentation, it should be understood that this manner of description encompasses rearrangement, unless a particular ordering is required by specific language set forth below. For example, operations described sequentially or staged may in some cases be rearranged or performed concurrently or in parallel configuration. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by one of ordinary skill in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise. Furthermore, not all alternatives recited herein are equivalents.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to the illustrated embodiments. Such terms are not, however, intended to imply absolute relationships, positions, and/or orientations unless otherwise indicated. For example, with respect to an object, an “upper” part can become a “lower” part simply by turning the object over. Nevertheless, it is still the same part and the object remains the same.

The features described herein with regard to any example can be combined with other features described in any one or more of the examples, unless otherwise stated.

To facilitate review of the various aspects of the disclosure, the following explanations of specific terms are provided:

Adjacent: When used in reference to the position of one or components of a device, this term refers to a physical orientation (or ordering) of the components of the device (e.g., fluid phase separator, or any of the components thereof, such as the inlet section, the outlet section, or the capillary cells) and another component of the device wherein the reference component and the other component are physically associated, either directly or through one or more intervening components.

Contact Angle: As used herein, the contact angle is a measurement of the degree of wetting between a liquid droplet on a solid surface surrounded by a second continuous, immiscible liquid, and is defined as the angle between a tangent line to the liquid droplet and the solid surface at the point where the perimeter of the liquid drop and the solid surface meet.

Downstream: As used herein, when referring to a fluid flow with a point of origin and a net vector of fluid travel, downstream is defined as being further from the point of origin of the fluid flow along the direction of the net vector of fluid travel.

Fluid Phase: As used herein, a fluid phase is a gaseous phase, a liquid phase, or a mixture thereof. Unless otherwise specified, the use of the term “fluid” phase may encompass any gas, liquid, or mixture thereof. Phases in relationship to each other may appear to be discrete (dispersed) such as bubbles, droplets and slugs, or non-discrete (non-dispersed). Non-discrete fluid phase is the one which appears to be continuous throughout the (flow) volume of the device. Occasionally, in the channel flow s situation may occur where all phases are discrete with respect to each other.

Hydrophilic: As used herein, a material is considered hydrophilic when it tends to reduce the contact angle between an aqueous fluid phase and a physical surface of the hydrophilic material.

Hydrophobic: As used herein, a material is considered hydrophobic when it tends to increase the contact angle between an aqueous fluid droplet and a physical surface of the hydrophilic material.

Non-wetting: As used herein, a phase is considered non-wetting when it has the highest contact angle with a capillary surface of any phase in a mixture of fluid phases. This term is used comparatively and the determination of the wetting and non-wetting phase or phases of any mixture of fluid phases is based on a comparison of the contact angle of each phase with a solid surface, unless explicitly stated otherwise. For example, a phase with a 60° contact angle with a solid surface would be considered the non-wetting phase when in a two-phase mixture with another phase having a 30° contact angle with that surface, but would be considered the wetting phase when in a two-phase mixture with another phase having a 90° contact angle with that surface.

Wetting: As used herein, a phase is considered wetting when it has a lower contact angle with a capillary surface than another phase in a mixture of fluid phases. This term is used comparatively and the determination of the wetting and non-wetting phase or phases of any mixture of fluid phases is based on a comparison of the contact angle of each phase with a solid surface, unless explicitly stated otherwise. For example, a phase with a 60° contact angle with a solid surface would be considered the non-wetting phase when in a two-phase mixture with another phase having a 30° contact angle with that surface, but would be considered the wetting phase when in a two-phase mixture with another phase having a 90° contact angle with that surface.

### II. Introduction

The extraction and separation of fluid phases (that is, gas or liquid phases) from mixtures of insoluble gases and liquids is of concern in many industrial fields, including, among others, fuels production, pharmaceuticals, food, and hydrometallurgy.

These fluids may be segregated by separators of various designs; however, many of these designs rely on membranes or filters that include small pores to separate insoluble fluids. These devices may have low throughput, are unable to separate highly efficient extraction flow regimes, and the pores of the membranes on which they rely may be prone to fouling and contamination, which causes separator performance to decline. In some examples, the designs may rely on gravity to separate the fluid mixtures, which requires the construction of tall separator columns, often at great expense, which renders such separators unsuitable for any but large-scale operations. In some examples, the designs may be more energy intensive, such as centrifugal extractors, generating a separation driving force through spinning rotors.

These concerns can be addressed using the device described herein, as well as the methods of using the device. The disclosed device is capable of separating mixtures of fluid phases without the use of filters or membranes, and in a fashion that is independent of gravitational pull, while being able to separate highly efficient extraction flow regimes. Furthermore, the disclosed device may be readily scaled up via increasing the device count and running multiple devices in parallel to improve overall fluid throughput, and thus offer utility in both small- and large-scale operations where the separation of mixed fluids is required depending on the number of devices used. The disclosed devices can also be configured to run in series or staging to increase extraction performance.

### III. Capillary Phase Separators

Disclosed herein are devices that serve as multiphase fluid separators which perform phase separation of a mixture of phases with differing wetting behaviors. In particular aspects of the disclosure, the disclosed separators are fluid phase separators that can establish a capillary pressure gradient perpendicular to a flow direction through the separator. In a general case, the gradient is formed by providing a capillary channel with an angled profile, thereby creating a gradual profile in channel depth. The wetting phase (that is, in most instances, the phase with the greater contact angle with the walls of the capillary channel) will be urged towards the shallower section of the channel, while the non-wetting phase (that is, in most cases, the phase with the lower contact angle with the walls of the capillary channel) is urged towards the deeper portion of the capillary channel, thus separating the wetting and the non-wetting phase in a direction perpendicular to the flow direction.

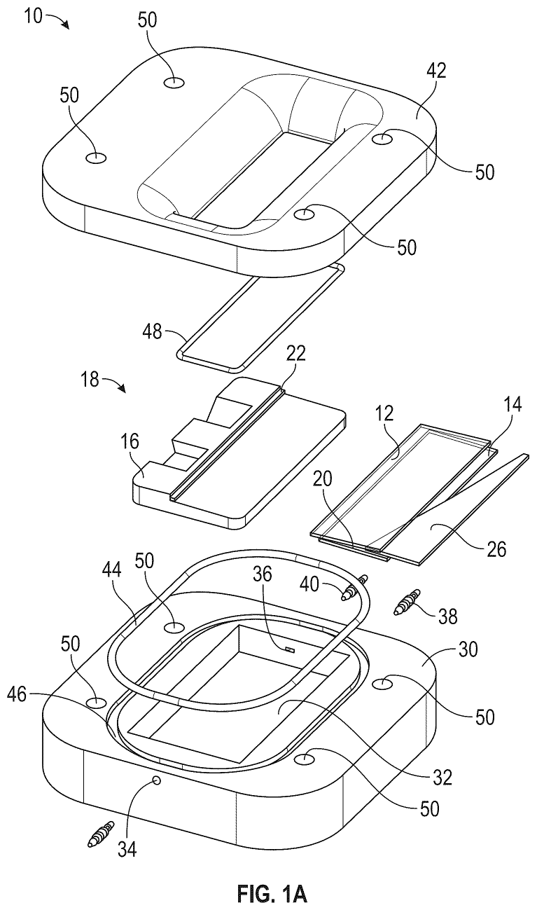

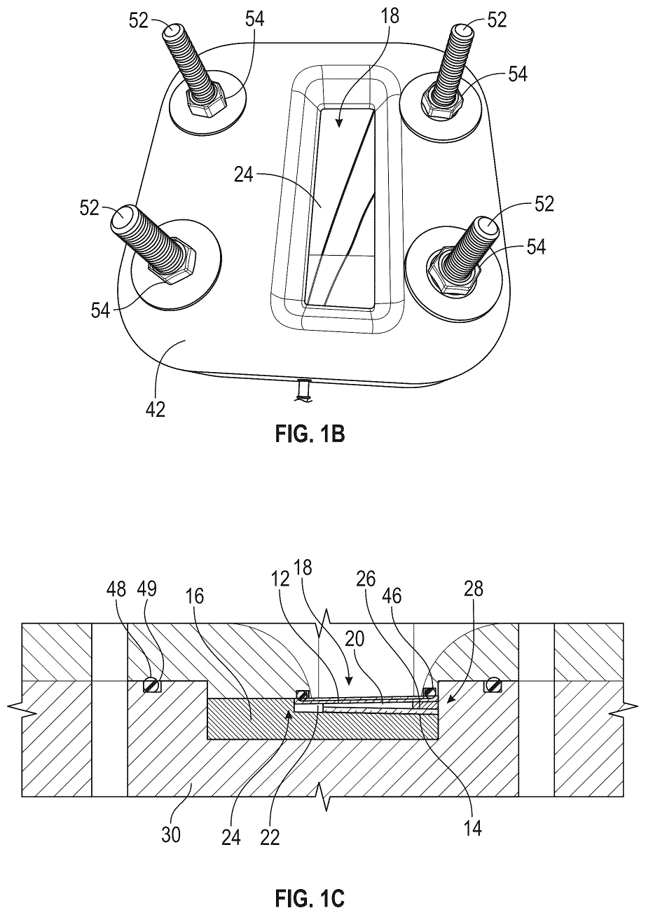

A capillary fluid phase separator according to one aspect of the disclosure is shown in FIGS. 1A-1C. In a generalized aspect, fluid phase separator 10 comprises a first plate 12 and a second plate 14. A mount 16 receives the first plate 12 and the second plate 14 to form the sidewalls of a capillary cell 18, as shown in FIGS. 1A and 1C. A gap 20 spacing the first plate 12 and the second plate 14 apart, as shown in FIG. 1C, can be established by a ridge 22 formed on the mount 16, disposed towards a first lateral side 24 of the capillary cell 18, and a shim 26 disposed towards a second lateral side 28 of the capillary cell 18.

In some aspects of the disclosure, the shim 26 can have a different thickness than the ridge 22, as shown in FIG. 1C. This causes the capillary cell 18 to have a greater depth towards either the first lateral side 24 or the second lateral side 28 than at the opposite side and orients the first plate 12 and the second plate 14 at an angle, a, relative to each other, as shown in FIG. 1C.

In certain aspects of the disclosure, the fluid phase separator 10 also comprises a housing 30 as illustrated in FIG. 1A. The housing 30 includes a cavity 32, sized to receive the mount 16, the first and second plates 12, 14, and the shim 26. In the aspect shown in FIG. 1A, the cavity 32 is accessible through an inlet 34 and an outlet 36, which are separated by the capillary cell 18. In some aspects of the disclosure, the outlet 36 can be split to deliver a first product stream to a first conduit 38 and a second product stream to a second conduit 40, as illustrated in FIG. 1A.

The fluid phase separator can also comprise a faceplate 42, as shown in FIG. 1A. The faceplate 42 is positioned atop the housing 30, as well as the components received in the cavity 32 (that is, the mount 16, the first and second plates 12, 14, and the shim 26). In some aspects of the disclosure, a first seal 44 (such as a gasket or O-ring) can be positioned between the faceplate 42 and the housing 30 and disposed in a first groove 46 formed in the surface of the housing 30, as shown in FIG. 1A. In some aspects of the disclosure, a second seal 48 can be positioned between the first plate 12 and the faceplate 42 and disposed in a second groove 49 formed on the surface of the faceplate 42, as indicated in FIG. 1C. The first seal 44 and the second seal 48 can prevent the escape of gas and/or liquid components of a fluid phase mixture from the fluid phase separator at any location, excluding the outlet 36, where fluid is intended to be dispensed/emitted.

As shown in FIG. 1A, the faceplate 42 and the housing 30 may further include one or more alignment holes 50. The alignment holes 50 can receive one or more alignment rods 52, which in some aspects of the disclosure can be threaded, as shown in FIG. 1B. The alignment rods 52 may, in such aspects, maintain the alignment of the faceplate 42 and the housing 30. It will be further appreciated that, in some aspects of the disclosure, the alignment rods may further provide a mechanism for securing the faceplate 42 to the housing 30 to maintain physical contact. Particularly, when the alignment rods 52 are threaded, one or more nuts 54 can be threaded onto the rods to provide a securing force to lock the faceplate 42 against the housing 30.

As discussed in further detail herein, the capillary cell 18 can be used to segregate mixtures of immiscible fluid phases that wet the first plate 12 and the second plate 14 differently. Generally, the non-wetting fluid phase (that is, the fluid phase with the higher angle of contact with the materials of the first plate 12 and the second plate 14) will be pushed to the side of the capillary cell with the highest depth and/or thickness, while the wetting phase (that is, the fluid phase with the lower angle of contact with the materials of the first wall 12 and the second wall 14) will collect in the side of the capillary cell with the lowest depth and/or thickness. As discussed in further detail herein, the capillary pressure exerted on the fluids in the capillary cell 18 can be adjusted by varying the angle between the first plate 12 and the second plate 14, as well as by varying the materials, advantageously allowing the fluid phase separator 10 to be adjusted for varying phase separation applications by varying the angle between the first plate 12 and the second plate 14.

In some aspects of the present disclosure, the specific geometry of the capillary cell 18 can be selected based on a desired maximum side depth of the capillary cell 18 (that is, the depth of the capillary cell 18 along the side of the capillary cell 18 with the greatest depth). This maximum depth can, for example, be selected to ensure that the interfacial force between a fluid within the capillary cell 18 and the first and second plates 12, 14 maintains an acceptable ratio relative to the gravitational force on the fluid. It will be appreciated by those in the art with the benefit of the present disclosure that this exact ratio and the maximum depth at which this can be achieved will vary based on the nature of the fluid mixture being separated, and environmental conditions such as interfacial tension, temperature and/or pressure.

In some specific aspects, capillary cell 18 can have a maximum side depth of 2.0 mm or less, such as 1.8 mm or less, 1.6 mm or less, 1.4 mm or less, 1.2 mm or less, 1.0 mm or less, 0.8 mm or less, 0.6 mm or less, 0.4 mm or less, or 0.2 mm or less.

In some aspects of the disclosure, the maximum side depth can be greater than the minimum side depth (that is, the side of the capillary cell 18 with the least depth) by a factor of 1.2 or greater, such as by a factor of at least 1.2, at least 1.4, at least 1.6, at least 1.8, or at least 2.0. In some aspects of the present disclosure, the maximum side depth can be greater than the minimum side depth by a factor of more than 2.0, such as 4.0, 6.0, 8.0, or 10.0. In some aspects of the disclosure, the maximum side depth can be greater than the minimum side depth by a factor of no more than 50, such as a factor of 50 or less, a factor of 40 or less, a factor of 30 or less, or a factor of 20 or less. In some aspects of the disclosure, the ratio between the maximum side depth and the minimum side depth can be produce an angle between the first plate 12 and the second plate 14 that ranges from 0.5° to 20°.

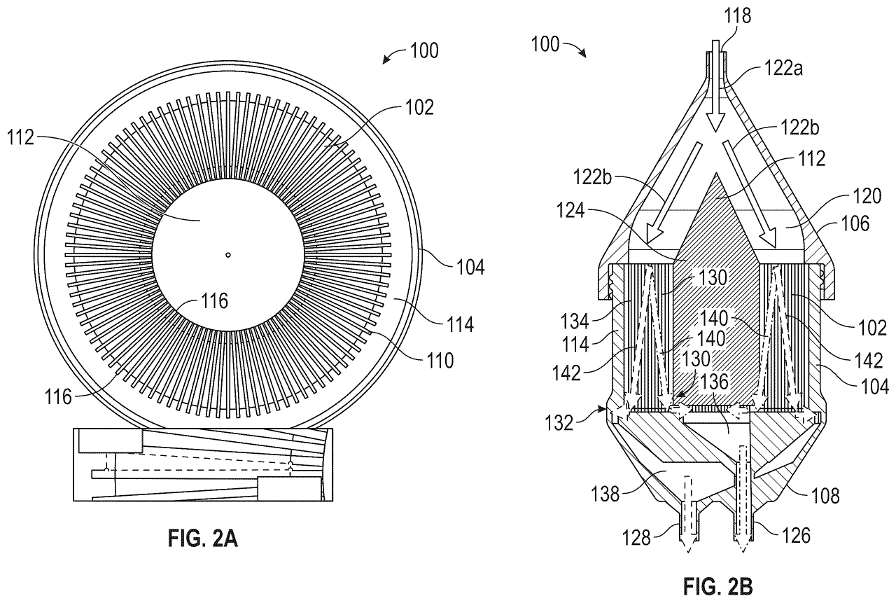

To improve the throughput of a fluid phase separator, the basic structure of the phase separator 10 can be scaled up in an apparatus that offers a plurality of capillary cells that can operate in parallel with one another. For example, FIGS. 2A and 2B show a fluid phase separator 100 according to another aspect of the present disclosure. Fluid phase separator 100 comprises a plurality of capillary cells 102 arranged to operate in parallel. The fluid phase separator 100 comprises a cylindrical housing 104 extending along a longitudinal axis, a conical inflow section 106, and an outflow section 108 (which can be conical and/or tapered), as shown in FIG. 2B.

The cylindrical housing 104, as shown in FIG. 2A, can contain a plurality of dividers 110 circumferentially spaced apart and extending between a central column 112 and an internal wall 114 of the cylindrical housing 104 to define the plurality of capillary cells 102. In some aspects of the present disclosure, the dividers 110 can be retained at a specific spacing by providing corresponding matched pairs of notches 116 in the central column 112 and the internal wall 114. The notches 116 can be sized such that the dividers 110 can be removably inserted into a corresponding matched pair of notches 116, with each divider 110 forming a single capillary cell 102, wherein each adjacent divider 110, the central column 112, and the internal wall 114 form the sides of the capillary cells 102.

In such aspects of the disclosure, each divider 110 will be oriented at an angle relative to each adjacent divider, due to the circumferentially spaced apart divider arrangement, with the angle determined by the number of dividers 110 retained in the cylindrical housing 104. Thus, a greater or lesser angle (and therefore a greater or lesser capillary gradient) can be obtained by varying the number of dividers 110 retained within the housing 104. It will be appreciated that because, as described above in relation to fluid phase separator 10, different angles of the capillary cells 102 will be appropriately selected for the separation of different mixtures, the number of dividers 110 in the housing 104 can be adjusted to ensure the correct angular spacing between adjacent dividers 110.

The conical inflow section 106 can be removably attached (for example, by means of threaded engagement, or sanitary clamps, not illustrated) with to the cylindrical housing 104. The conical inflow section 106 comprises an inlet end 118 and an outlet end 120. In some aspects of the disclosure, as shown in FIG. 2B, the central column 112 further comprises a conical projection 124 that extends along the longitudinal axis into the outlet end 120 of the conical inflow section 106. The conical projection 124 can be positioned such that an incoming fluid mixture (for example, a fluid mixture 122 as shown in FIG. 2B) impinges on a proximal portion of the conical projection 124 and is radially dispersed.

In some aspects of the disclosure, one or more alignment pegs, ridges, or seals may be present between any of the conical inflow section 106, the cylindrical housing 104, and the outflow section 108. The presence of one or more of these features may improve the alignment of the inflow section, the cylindrical housing 104, or the outflow section 108 relative to one another.

In some aspects of the disclosure, the dividers 110 can comprise a glass material. In other aspects of the disclosure, the dividers 110 can comprise a metal material. In other aspects of the disclosure, the dividers 110 can comprise a polymer material. It will be appreciated that different materials may be used for the dividers 110 to improve the separation of different fluid mixtures, as different fluids may have different contact angles with different materials used for the dividers 110. In some examples, different materials may be used for the dividers 110 to improve the response to surface treatment.

Should it be necessary to remove or change any of the dividers 110 from the cylindrical housing 104, the conical inflow section 106 can be detached (for example, by unscrewing the threaded engagement) from the cylindrical housing to allow access to the dividers, which may thereafter be removed from the notches 116 and replaced, if necessary. The conical inflow section 106 can thereafter be reattached to the housing 104.

In some aspects of the disclosure, one or more seals or gaskets can be disposed between the inflow section 106 and the cylindrical housing 104 to prevent a portion of the fluid mixture 122 from escaping from the fluid phase separator 100.

The outflow section 108 can be removably or fixedly attached to the cylindrical housing 104 at an end that is opposite to the inflow section 106. As shown in FIG. 2B, the outflow section 108 comprises a first fluid outlet 126 and a second fluid outlet 128, each in fluid communication with the plurality of capillary cells 102. According to one aspect of the disclosure, the first fluid outlet 126 and the second fluid outlet 128 can be positioned such that each of the first and second fluid outlets 126, 129 independently captures and expels a different component of the fluid mixture that is introduced into fluid phase separator 100. For example, as illustrated in FIG. 2B, the first fluid outlet 126 can be positioned to receive fluid flow from a radially interior portion 130 of a downstream end 132 of the capillary cells 102, and the second fluid outlet 128 can be positioned to receive fluid flow from a radially exterior portion 134 of the downstream end 132 of the capillary cells 102.

In some aspects of the disclosure, the outflow section 108 can comprise a conical channel 136 disposed towards the center of the outflow section 108. The conical channel 136 can extend between the radially interior portion 130 of the downstream end 132 of the capillary cells 102 and the first fluid outlet 126, as shown in FIG. 2B, and can deliver fluid flow from the capillary cells 102 to the first fluid outlet 126. In some aspects of the disclosure, the outflow section 108 can also comprise an annular channel 138 disposed radially outwards of the conical channel 136. The annular channel 138 can extend between the radially exterior portion 134 of the downstream end 132 of the capillary cells 102 and the second fluid outlet 128, as shown in FIG. 2B, and can deliver fluid flow from the capillary cells 102 to the second fluid outlet 128.

During use of fluid separator 100, a fluid mixture can be admitted through the inlet end 118 of the inflow section 106 as a linear flow, as indicated by arrow 122a. The fluid mixture can impinge on the conical projection 124 and be radially dispersed before reaching the capillary cells 102, as indicated by arrows 122b. For reasons similar to those discussed herein in relation to the function of the capillary cell 18 of the fluid phase separator 10 shown in FIG. 1A, the capillary cells 102 of the fluid phase separator 100 will separate the fluid mixture into a wetting phase and a non-wetting phase, represented by arrows 140 and 142, respectively. Because capillary cells 102 are narrower towards the radially interior portion 130 and wider towards the radially exterior portion 134 (as shown in FIG. 2A), the capillary cells 102 will separate the wetting phase 140 towards the narrower section (that is, the radially interior portion 130) of the capillary cells 102, and will separate the non-wetting phase 142 towards the wider section (that is, the radially exterior portion 134) of the capillary cells 102, with behavior substantially similar to that discussed herein in relation to the passage of fluid mixtures through the fluid phase separator 10 shown in FIG. 1A.

As it is segregated towards the radially innermost portions of the capillary cells 102, the wetting phase 140 will be collected in the conical channel 136 and directed to the first fluid outlet 126. Likewise, as it is segregated towards the radially outermost portions of the capillary cells 102, the non-wetting phase 142 will be collected in the annular channel 138 and directed to the second fluid outlet 128. Thus, the fluid phase separator 100 is suitable for separating mixtures of fluid phases with a plurality of capillary cells configured to operate in parallel.

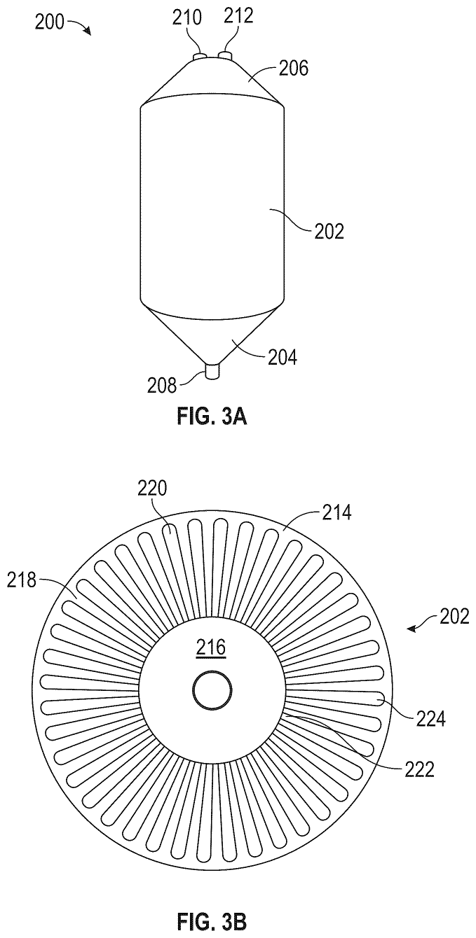

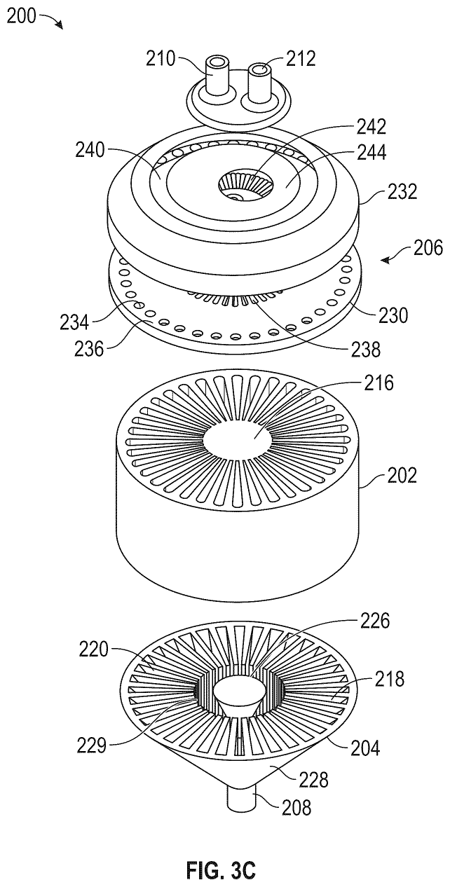

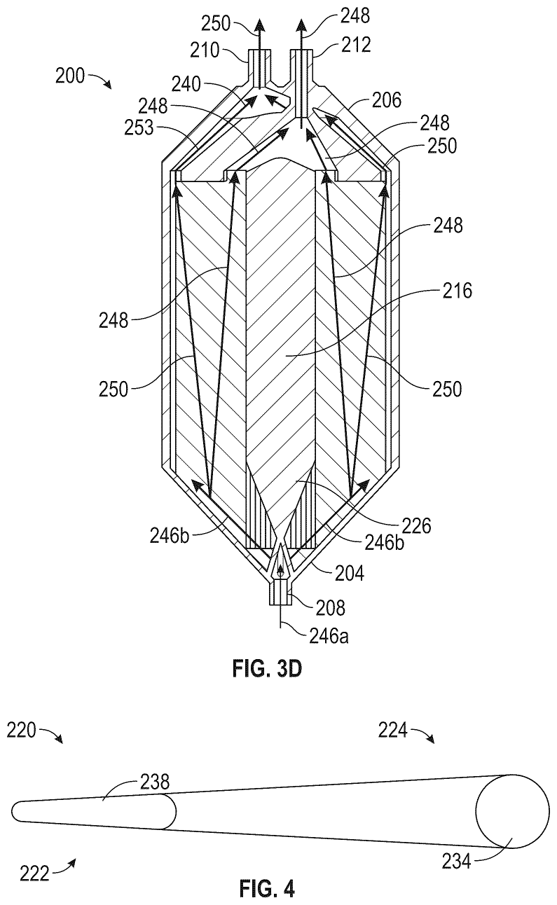

A fluid phase separator 200 with an array of capillary cells that operate in parallel according to another aspect is shown in FIGS. 3A-3D. The fluid phase separator 200 can have a substantially similar configuration and an identical or substantially similar function to the fluid separator 100 disclosed herein, with particular physical and/or operational aspects/parameters described in more detail below.

With reference to FIG. 3A, the fluid phase separator 200 can comprise a cylindrical body 202, an inlet section 204, and an outlet section 206. The inlet section 204 and the outlet section 206 can have a conical or tapered geometry as shown in FIG. 3A. The fluid phase separator 200 can also comprise a fluid inlet 208 extending from the upstream end of the inlet section 204, as well as a first fluid outlet 210 and a second fluid outlet 212 extending from the downstream end of the outlet section 206.

A cross sectional view of the cylindrical body 202 is presented in FIG. 2B. As shown in FIG. 2B, the cylindrical body 202 comprises an external wall 214 defining an interior space, a central column 216, and a plurality of vanes 218 extending between the external wall and the central column, which divide the interior space into a plurality of axially extending and radially extending capillary cells 220.

As shown in FIG. 3B, the plurality of vanes 218 can be circumferentially spaced apart from one another around the circumference of the cylindrical body 202. This circumferential spacing results in an angular offset between adjacent vanes 218, and correspondingly, an angle in each capillary cell 220 that results in a plurality of capillary cells 220 that grow in thickness as they extend axially from the central column 216, with the thinnest portion of the capillary cells 220 occurring at the radial innermost end 222 of the capillary cells, and the thickest portion of the capillary cells occurring at the radially outermost end 224 of the capillary cells 220. In some aspects of the disclosure, such as that shown in FIG. 3B, the spacing between the vanes 218 can be uniform, such that each capillary cell 220 has an identical or substantially identical geometry.

Turning now to FIG. 3C, the interior of the inlet section 204, positioned upstream of the cylindrical body 202, is shown in greater detail. As shown in FIG. 3C, a conical end portion 226 of the central column 216 can extend axially into the inlet section 204 of the phase separator 200 in some aspects. In some aspects of the present disclosure, the conical end portion 226 and the central column 216 can be a unitary structure. Similarly, in some aspects of the disclosure, the vanes 218 can extend axially into the inlet section 204 of the phase separator 200, where they can join with a conical wall section 228 that defines the interior volume of the inlet section 204.

Due to the tapering geometry of the conical end portion 226 in such aspects, a gap 229 can exist between the central column 216 and the radially innermost portion of the vanes 218. As the conical end portion 226 of the central column 216 grows progressively wider in the downstream direction, the gap 229 correspondingly narrows until the vanes 218 and the central column 216 join at the upstream end of the cylindrical body 202. Advantageously, this facilitates the radial dispersal of a mixed phase fluid stream and directs the mixed phase fluid into the capillary cells 220 from an early point after its entry into the phase separator 200.

FIG. 3C also illustrates the outlet section 206, positioned downstream of the cylindrical body 202, in greater detail. As shown in FIG. 3C, the outlet section 206 comprises a divider plate 230, a collector manifold 232, and the first and second outlets 210, 212. The divider plate 230 is positioned between the downstream end of the cylindrical body 202 and the upstream end of the channel manifold 232, and the collector manifold 232 extends between the divider plate 230 and the outlets 210, 212.

As shown in FIG. 3C, the divider plate 230 can comprise a plurality of apertures 234 located along a radial periphery 236 of the divider plate 230, and a plurality of slots 238 disposed towards the center of the divider plate 230. The number of apertures 234 and slots 238 can be selected to correspond to the number of capillary cells 220 in the phase separator 200 and can be radially and circumferentially aligned with the radially outermost end portion 224 (that is, the widest end portion) and the radially innermost end portion 222 (that is, the narrowest end) of the capillary cells 220 respectively, as illustrated in FIG. 3B. The divider plate 230 can also block off a central portion of each of the capillary cells 220 extending between the radially outermost end portion 224 and the radially innermost end portion 222. Thus, as illustrated in FIG. 4, the capillary cells 220 can each be open at the radially innermost (that is, the narrowest) end portion 222 through a slot 238, and the open at the radially outermost (that is, the widest) end portion 224 through an aperture 234. Thus, fluids can exit the downstream end of the capillary cells 220 only through the radially innermost end portion and the radially outermost end portion 224 of each capillary cell (and correspondingly through the slots 238 and the apertures 234).

The collector manifold 232 is positioned downstream from the separator plate 230 and connects the apertures 234 and the slots 238 to the first outlet 210 and the second outlet 212 respectively. As shown in FIG. 3C, the collector manifold 232 can include a first collector 240 disposed towards a peripheral portion of the collector manifold 232. The first collector 240 can have a substantially annular cross section that narrows in the downstream direction, to facilitate collection of fluid flow from the radially disposed apertures 234 towards the first outlet 210, which may in some aspects be located nearer to an axial centerline of the fluid phase separator 200 than the apertures 234, as shown in FIG. 3C. The collector manifold 232 can also include, in some aspects of the disclosure, a second collector 242, located towards the center of the collector manifold 232. The second collector 242 can, in some aspects of the disclosure, have a substantially conical shape, to facilitate the collection of fluid flow from the slots 238 and concentration of that flow towards the second outlet 212. The first collector 240 and the second collector 242 are separated by a divider 244, which prevents fluid from leaking from the first collector 240 to the second collector 242, or vice versa.

FIG. 3D illustrates the separation of a fluid mixture passing through the fluid phase separator 200. In use, a fluid mixture can be admitted through the inlet end 208 of the inflow section 204 as a linear flow, indicated by arrow 246a in FIG. 3D. The fluid mixture can impinge on the conical projection 226 and be radially dispersed, as indicated by arrows 246b, before reaching the capillary cells 202. For reasons similar to those discussed herein in relation to the function of the capillary cells 18, 102 of the fluid phase separators 10,100 (as described in relation to FIGS. 1A and 2B, respectively), the capillary cells 220 of the fluid phase separator 200 will separate the fluid mixture into a wetting phase 248 and a non-wetting phase 250. Because capillary cells 220 are narrower towards the radially interior portion 222 and wider towards the radially exterior portion 224, the capillary cells 220 will separate the wetting phase 248 towards the narrower section (that is, the radially interior portion 222) of the capillary cells 220 and will separate the non-wetting phase 250 towards the wider section (that is, the radially exterior portion 224) of the capillary cells 220, as discussed herein in relation to the passage of fluid mixtures through the fluid phase separators 10, 100.

As it is segregated towards the radially innermost portion 222 of the capillary cells 220, the wetting phase 248 will be collected in the second collector 242 and directed to the second fluid outlet 212. Likewise, as it is segregated towards the radially outermost portions of the capillary cells 220, the non-wetting phase 250 will be collected in the first collector 240 and directed to the first fluid outlet 210. Thus, the fluid phase separator 200 is suitable for separating mixtures of fluid phases with a plurality of capillary cells configured to operate in parallel.

In a manner similar to that described above in relation to the fluid phase separator 100 described in FIGS. 2A and 2B, each vane 218 of FIGS. 3B and 3C will be oriented at an angle relative to each other vane 218, due to the circumferentially spaced apart arrangement of the vanes 218, with the angle determined by the number of vanes 218 dividing the interior of the fluid phase separator 200. Thus, a greater or lesser angle (and therefore a greater or lesser capillary gradient) can be utilized by varying the number and spacing of the vanes 218. It will be appreciated that because, as described above in relation to fluid phase separators 10 and 100, different angles of the capillary cells 220 will be appropriate for the separation of different mixtures, a greater or lesser number of vanes 218 can be used, to ensure a desired angular spacing between adjacent vanes 218.

In some aspects of the present disclosure, the fluid phase separator 200 can be additively manufactured. Advantageously, additively manufacturing the fluid phase separator 200 allows the ability to create the intricate interior structures of the presently disclosed fluid phase separator that would be impossible to achieve using conventional manufacturing techniques. Accordingly, in such aspects, components of the fluid phase separator 200 can be integrally formed to produce a monolithic structure. Materials suitable for additively manufacturing the fluid phase separator 200 include metal and polymer build substrates, for example, stainless steel, inconel super alloy, polyethylene terephthalate (PET), polyethylene terephthalate glycol-modified (PETG), polylactic acid (PLA), polymethyl methacrylate (PMMA), ceramics, glass, wood, wool, or a combination thereof. Additionally, additively manufacturing a monolithic-type structure eliminates or reduces areas for sealing, increasing reliability.

In some aspects of the disclosure, the separators disclosed herein, and/or any components thereof, can be manufactured with alternative methods, such as laminar construction techniques known to those in the art with the benefit of the present disclosure. In some aspects of the disclosure, the fluid phase separators disclosed herein can be constructed of recyclable materials, including recyclable polymers and metals.

In each of the fluid phase separators 10, 100, 200 disclosed herein, the phase separating characteristics of the capillary cells 18, 102, 220 can be modified and/or improved by including one or more coatings on the walls of the capillary cells (that is, the plates 12, 14 of the phase separator 10, the dividers 110 of the phase separator 100, or the vanes 218 of phase separator 200) that modify the wetting behavior of the fluid phases passing through the capillary cells 18, 102, 220.

In some aspects of the present disclosure, a hydrophobic coating can be used to increase the contact angle (that is, reduce the wetting) of aqueous phases. Hydrophobic coatings can include self-assembling monolayers, silanes, polydimethylsiloxane, or a combination thereof.

In some aspects of the present disclosure, a hydrophilic coating can be used to decrease the contact angle (that is, increase the wetting) of aqueous phases. Hydrophilic coatings can include perfluoropolyether (Zdol), a hydrogel, or a combination thereof.

In some aspects of the present disclosure, the hydrophobic or hydrophilic coatings can be applied in a gradient on any plate to which they are applied, such that a first portion of the plate 12, 14, divider 110, or vane 218 (for example, a first lateral portion) will contain a greater concentration of the coating, and thus have a greater hydrophobicity or hydrophilicity than a second portion of the plate 12, 14, divider 110, or vane 218 (for example, a second lateral portion). This may facilitate the separation of hydrophobic or hydrophilic fluids to different portions of the capillary cell 18, 102, 220.

In some aspects of the present disclosure, coatings including a catalyst in addition to or in lieu of the hydrophobic or hydrophilic material. In such aspects of the disclosure, the catalyst may cause or accelerate a reaction with one or more of the fluid phases.

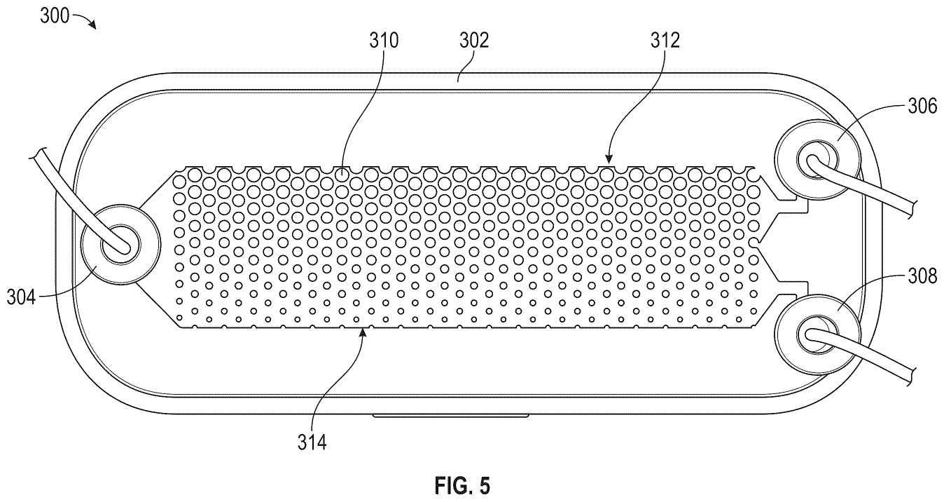

The example fluid phase separators disclosed herein can, in some aspects of the disclosure, be used alongside a flow plate microchannel phase separator, such as the separator 300 illustrated in FIG. 5. The fluid phase separator 300 comprises a sealed flow plate 302, and inlet port 304, a first outlet port 306, and a second outlet port 308. The microchannel phase separator also comprises an array of columns 310 formed on the sealed flow plate 302. In some aspects of the disclosure, the flow plate 302 may be sealed by a cover plate (not shown) to prevent fluid from entering or exiting the fluid phase separator, except for at the intended inlet and outlet ports 304, 306, 308.

As shown in FIG. 5, the columns 310 are distributed according to a predetermined size gradient, with the columns 310 positioned nearer a first lateral side 312 of the flow plate 302 having a larger diameter than the columns 310 positioned nearer a second lateral side 314 of the flow plate 302. This arrangement provides a passageway network through the array of columns 310 with narrower passageways towards the first lateral side 312 of the flow plate 302 and larger passageways towards the second lateral side 314 of the flow plate 302. The narrower passageways along the first lateral side 312 of the flow plate 302 impose a larger contact angle between a fluid and the larger columns 310 positioned along the first lateral side 312 of the flow plate 302, which in turn impedes the passage of the non-wetting phase of a fluid mixture. Because the non-wetting phase of a fluid mixture has difficulty passing through the smaller passageways located towards the first lateral side 312 of the flow plate 302, it will be segregated towards the second lateral side 314 of the fluid flow plate 302, and thus the wetting phase will be segregated towards the first lateral side 312 of the fluid flow plate 302.

Further details about flow plate microchannel phase separators, such as the separator 300, are available in U.S. Pat. No. 9,895,480 and U.S. Patent Application No. US2018/0258381, the relevant portions of which are incorporated herein by reference.

Any of the fluid phase separators 10, 100, 200, 300, according to any aspect disclosed herein may be used with one or more fluid phase separators 10, 100, 200, 300 according to any aspect disclosed herein to form an array of fluid phase separators, or an assembly comprising two or more fluid phase separator. In some aspects of the disclosure, the fluid phase separators 10, 100, 200, 300 can be arranged in parallel, for example, to improve the throughput of the fluid phase array. In some aspects of the disclosure, the fluid phase separators 10, 100, 200, 300 can be arranged in series, such that one or more output fluids from a first fluid phase separator 10, 100, 200, 300 forms at least part of the input fluid for a second fluid phase separator 10, 100, 200, 300 downstream from the first fluid phase separator. It will be appreciated that when two or more fluid phase separators 10, 100, 200, 300 are arranged in series, one or more additional fluids can be added to the fluid mixture between any upstream fluid phase separator 10, 100, 200, 300 and any fluid phase separator downstream from that fluid phase separator 10, 100, 200, 300.

### IV. Mechanics of Phase Separation

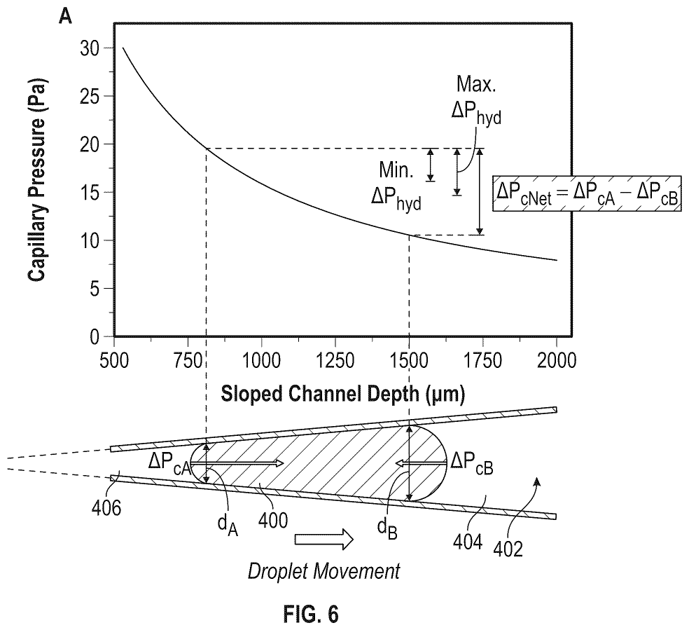

When a mixture of immiscible fluid phases passes through the phase separator 10, 100, 200 (that is, when it travels from an inlet, through one or more capillary cells, towards one or more of the outlets disclosed herein), it may form a plurality of fluid droplets, such as the non-wetting droplet 400 in the exemplary capillary cell 402 shown in FIG. 6. As described in greater detail below, the net capillary pressure ΔP_{cNet} on the non-wetting droplet 400 will be higher on the narrow portion 404 of the capillary cell 402, which will tend to push the droplet 400 towards the wider portion 406 of the capillary cell 402. This ultimately causes the non-wetting phase to stratify from the wetting phase, and coalesce.

The magnitude of ΔP_{cNet} is the net difference (see Equation 1) between the two opposing and unequal local interfacial capillary pressures (ΔP_{cA}) and (ΔP_{cB}) applied laterally on both ends of the non-wetting droplet 400, as shown in FIG. 6:

$$Δ {P}_{cNet} = Δ {P}_{c A} - Δ {P}_{c B} \qquad ( Equation 1 )$$

With ΔP_{cA} being the larger local interfacial capillary pressure created at the narrower side of the interface, and ΔP_{cB} the smaller pressure generated at the wider side.

The Young-Laplace equation (Equation 2) relates the magnitude of the local interfacial capillary pressure (ΔP_{c}) to its governing parameters; the interfacial tension (σ) between the two immiscible fluids, and the radii of curvatures at the interface

$$( \frac{1}{r 1} and \frac{1}{r 2} ) :$$

$$Δ {P}_{c} = σ ( \frac{1}{r 1} + \frac{1}{r 2} ) \qquad ( Equation 2 )$$

For a droplet of equal curvatures at the interface (r1=r2), ΔP_{c} can be expressed using Equation 3:

$$Δ {P}_{c} = \frac{2 σ}{r} \qquad ( Equation 3 )$$

The radius r can be calculated using Equation 4:

$$r = \frac{h}{cos ( θ )} = \frac{d}{2 cos ( θ )} \qquad ( Equation 4 )$$

With h being half the depth (d) of the sloped channel at the interface

$$( h = \frac{d}{2} ) ,$$

and (θ) the contact angle formed between the wetting organic phase (example in this work: Tributyl phosphate (TBP) and Diethyl succinate (DS) mixture) and the solid surface (example in this work: PETG) in the presence of a non-wetting phase (example in this work: aqueous mixture). Consequently, ΔP_{c} can be written as Equation 5:

$$Δ {P}_{c} = \frac{2 σ cos ( θ )}{h} = \frac{4 σ cos ( θ )}{d} \qquad ( Equation 5 )$$

Thus, ΔP_{cNet} can be expressed as Equation 6:

$$Δ {P}_{cNet} = Δ {P}_{c A} - Δ {P}_{c B} = 4 σcos ( θ ) ( \frac{1}{{d}_{A}} - \frac{1}{{d}_{B}} ) \qquad ( Equation 6 )$$

With d_{A} and d_{B} being the depth of the sloped channel at the narrowest and widest sides of the interface, respectively (d_{A}<d_{B}). For a given channel architecture and under invariable σ and θ values, it can be observed that ΔP_{cNet} is dependent on d_{A} and d_{B}, which are in turn determined by the non-wetting droplet dimensions.

For a given channel architecture and under invariable σ and θ values, it can be observed that ΔP_{cNet} is dependent on d_{A} and d_{B}, which are in turn determined by the non-wetting droplet dimensions. FIG. 6 shows the magnitudes of ΔP_{c} generated in an example phase separator similar to the fluid phase separator 200 discussed herein, under TBP/DS and synthetic brine across the available channel depths with σ=12.8 mN/m and 0=72°. ΔP_{c} decreases from 29.9 Pa at the narrowest end of the channel (d=530 μm) to 7.9 Pa at the widest edge (d=2000 μm). An illustration of ΔP_{cNet} exerted on a non-wetting aqueous droplet extending from d_{A}=800 μm to d_{b}=1500 μm is presented as an example. For the sloped channel to exert ΔP_{cNet} needed for separation, the non-wetting droplet should have a diameter larger than 530 μm, corresponding to a minimum volume of 77.95 nL. It can also be noticed that

$$\frac{\partial Δ {P}_{c}}{\partial d}$$

increases with decreasing channel depths. This favorable effect imposes an increased resistance on the non-wetting aqueous phase as it approaches the narrower side of the channel where the organic outlet is located.

As the non-wetting phase is increasingly segregated towards the wide end of the capillary cell 402, the wetting phase is increasingly segregated towards the narrow end of the capillary cell 402, resulting in a stratification of the wetting and non-wetting phases, which allows for the respective phases to be selectively collected as disclosed herein.

This separation of phases can result in the separation of a mixture of immiscible fluid phases with differing angles of contact with the boundaries (that is, the wall) of the capillary cell 18 or capillary cells 102, 220 of any example fluid phase separators 10, 100, 200 disclosed herein. In one aspect of the disclosure, a first mixture, M₁ comprising a first fluid A and a second fluid B at a first concentration, indicated by Equation 7, may be admitted to the fluid phase separator 10, 100, 200. The differing capillary pressure on the first fluid A and the second fluid B can separate or partially separate the first mixture M₁ into a second mixture, M₂ and a third mixture M₃. The second mixture M₂ may comprise the first fluid A and the second fluid B at a second concentration indicated by Equation 8. The third mixture M₃ may comprise the first fluid A and the second fluid B at a third concentration as indicated by Equation 9. The concentrations of the second and third mixtures will be related to the concentration of the first mixture such that Equation 10 is satisfied.

$${M}_{1} = {A}_{1} + {B}_{1} \qquad ( Equation 7 )$$

$${M}_{2} = {A}_{2} + {B}_{2} \qquad ( Equation 8 )$$

$${M}_{3} = {A}_{3} + {B}_{3} \qquad ( Equation 9 )$$

$${A}_{1} = {A}_{2} + {A}_{3} ; {B}_{1} = {B}_{2} + {B}_{3} \qquad ( Equation 10 )$$

It will be appreciated that in some cases, the separation of the first fluid A and the second fluid B can be complete; such that M₂=A₁ and M₃=B₁. However, in other cases, the separation of the first mixture M₁ into the second mixture M₂ and the third mixture M₃ may be incomplete, such that each of the second and third mixtures M₂, M₃ contain both the first fluid A and the second fluid B, albeit in differing concentrations of each fluid.

In some aspects of the disclosure, the above parameters can represent a mass fraction, a molar fraction, or a volume fraction of the first fluid A and the second fluid B. In some aspects of the disclosure, the separation of a mixture of fluids, such as the first fluid A and the second fluid B can be conducted and/or modified so as to separate fluids based on mass fraction, molar fraction, or volume fraction.

In some aspects of the disclosure, for a mixture of fluids comprising at least a first fluid and a second fluid, at least 50% of the first fluid is separated from the mixture, such as 50% or more, 60% or more, 70% or more, 80% or more, or 90% or more of the first fluid. In some aspects of the disclosure, all of the first fluid is separated from the mixture (that is, total separation occurs).

### V. Methods of Use

### A. Introduction

LLE is considered the primary industrial process for the extraction, separation, and recycling of minerals such as REEs and other valuable metals. LLE is also important in other chemical and biochemical industrial applications. Its utility stems from its cost-effectiveness, scalability, simplicity, and high material purity yielding up to 99.99%. In hydrometallurgy, a mineral-rich aqueous phase is intimately contacted with an organic phase comprising solute-selective extractant(s) and a diluent. After metal transfer across the generated interface, a liquid-liquid separation of the phases is required. With the highest redox potential value and heat capacity of any solid element, lithium is an integral component of numerous renewable energy, transportation, communication, information, and defense technologies. 65% of lithium global end-use markets were dedicated to Lithium-Ion Battery (LIB) in 2020, and the battery market is expected to grow by a factor of 5 or 10 during the next decade. Thus, the demand for lithium is projected to increase by over 40 times in 2040 relative to 2020.

It is estimated that 65% of economic concentrations of lithium are globally found in brines; with approximately 59% in continental brines, 3% in geothermal brines, and 3% in oilfield brines, with most sources located in South America. Along with adsorption, and ion exchange, LLE is a promising lithium extraction process, particularly suited for brines with modest lithium concentrations such as geothermal brines in the United States. It is expected that the recovery of lithium from geothermal brines in the U.S. can constitute a reliable and secure domestic supply of that element. LLE has been extensively used for the successful recovery of lithium from brines, recycled LIB leachates, seawater, produced water, along other real or synthetic sources.

Multiple commercial extractants have been used for the recovery of lithium and REE such as D2EHPA, vinyl neodecanoate (trade name Versatic 10), liquid phosphine oxide (trade name Cyanex 923), ionic liquids such as tricaprylylmethylammonium chloride (trade name Aliquat 336), and Tributyl Phosphate (TBP). TBP, a neutral organophosphorus, is one of the most widely used and investigated extractants of lithium from brine and other sources. These extractants, however, require organic diluents to reduce the extractant's viscosity and density to improve lithium mass transfer. While multiple diluents such as MIBK, kerosene, and 2-octanol have been used with TBP, Diethyl Succinate (DS) has been favored given its non-toxicity, high flash point, low volatility, and minimal solubility with water. DS also has a high polarity, which allows the polar metal-extractant complex to easily dissolve in the organic phase. Moreover, FeCl₃ as a co-extractant for TBP has been found to significantly increase the extraction performance via the formation of FeCl₄⁻ anion. The TBP/FeCl₃ system extracts lithium from brine via the following reactions:

$${FeCl}_{{3}_{( a q )}} + {Cl}_{( a q )}^{-} ↔ {FeCl}_{{4}_{( a q )}^{-}} \qquad ( Equation 11 )$$

$${Li}_{( a q )}^{+} + {FeCl}_{{4}_{( a q )}^{-}} + {nTBP}_{( o r g )} ↔ {[ {Li ( TBP )}_{n} ] [ {FeCl}_{4} ]}_{( o r g )} \qquad ( Equation 12 )$$

It will be appreciated that many of these principles will apply in other hydrometallurgical processes, such as REE extraction via LLE, given the physiochemical similarities across the systems.

Mixer-settlers are the most widely conventional devices in hydrometallurgy, while column and centrifugal extractors are dedicated to specialized applications. However, these separation methods have notable drawbacks, particularly in achieving high throughput in fluid phase separation systems. In mixer-settlers, gravitational liquid-liquid separation is a process bottleneck, requiring three times the residence times of the mixing stage. For mixing times of 3-20 minutes, a settling period three times that duration has been reported, extending up to weeks if stable emulsions are formed. The separation performance is further reduced by the presence of fine particles and impurities, often the case with hydrometallurgical feeds.

An alternative system for hydrometallurgy relies on coupling a micro-extractor, which facilitates contact between the aqueous phase and the organic phase (for example, to remove lithium from a brine as described above in equations 11 and 12), and a micro-separator to separate the aqueous and organic phases following the extraction step. Micro-extractors and micro-separators can improve the throughput of LLE by respectively accelerating its solute extraction and liquid-liquid separation stages to seconds instead of minutes, as compared to mixer-settlers. Although the exact mechanism of mass transfer depends on the specific architecture and fluidic conditions, these devices generally seek to minimize the solute diffusional lengths and times, maximize the interfacial surface area, while developing internal convective flows to improve mass transfer. As a result, micro-extractors drastically reduce the total extraction time when compared to conventional systems, with mass transfer coefficients two to three orders higher.

Micro-extractors also offer a noticeable reduction of the power input requirements (0.2-20 KJ/m3) compared to conventional extractors such as centrifugal extractors (850-2600 kJ/m3), mixer-settlers (150-250 KJ/m3), and agitated extraction columns (0.5-190 KJ/m3). For these reasons, achieving industrial throughputs via scaled up units comprising multiple LLE microfluidic units promises important advantages such as increased process efficiency, reduced chemical and energy consumption, smaller footprint, in addition to flexible investment and operation costs.

Micro-extractors can operate as “passive” or “active devices, each functioning under different two-phase flow patterns. In hydrometallurgy and other applications, “passive” micro-extractors are most commonly used given their simplicity and independence from external power sources. Simple T- and Y-junction micro-extractors connected to straight capillary extraction channels can create slug/droplet two-phase flow regimes for the recovery of various metallic elements from brines. Despite their merits, these previous systems were mainly low throughput, requiring an extremely large number of units to reach industrial production levels.

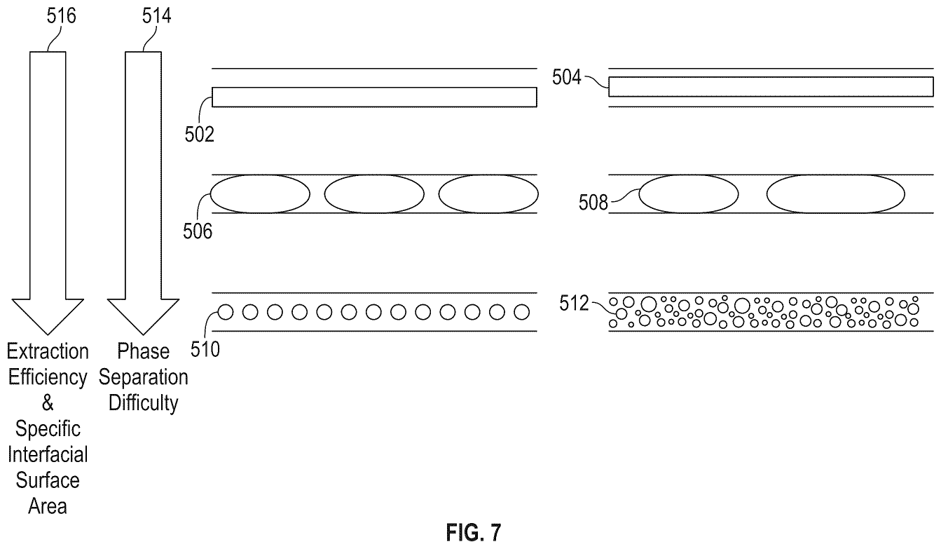

Typical micro-extractors operate in a two-phase flow regime. The two-phase flow regime in micro-extractors not only affects mass transfer efficiency and mechanism, but also the difficulty of the subsequent phase separation in micro-separators. As seen in FIG. 7, there can be parallel flow 502, annular flow 504, regular slug flow 506, irregular slug flow 508, droplet flow 510, and dispersed droplet flow 512. While multiple two-phase flow patterns are reported, three main groups can be distinguished: parallel/annular flow, slug flow, and droplet/dispersed droplet flow. The appearance of these regimes is contingent on multiple parameters such as the relative ratio of fluidic forces (inertial, viscous, interfacial, and gravitational), surface wettability, the ratio of phases, and architectural features. As shown by arrows 514, 516 a trade-off exists between increased extraction efficiency and difficulty of phase separation. While the parallel/annular flow requires minimal phase separation, the small interfacial surface area, reduced mass transfer, instability of the interface, and low throughput limits the use of phase separation methods that operate in this regime.

Conversely, the interfacial tension-dominated slug flow is useful for its higher mass transfer and throughputs, in addition to the relative ease of separation. This improvement of mass transfer is promoted by the small diffusional distances and increased interfacial surface area. Additionally, the shear between the moving slugs and the walls induces strong internal convective circulation within the slugs that accelerates solute exchange.

This internal convective circulation regenerates the interfacial surface, redistributes the solute within the slug, and reduces the interfacial thickness. Once the slug size becomes smaller than the microchannel diameter, a droplet/dispersed droplet regime starts to emerge. This flow is characterized by an increase in interfacial surface area and mass transfer coefficient, but also phase separation challenges. It develops under inertial or viscous-dominated conditions, with microdroplets' diameters down to 5-150 μm for the dispersed droplet regime. In this pattern, mass transfer is also enhanced by the strong internal circulation within the droplets due to inertial deformation. Extraction in this regime is reported to be 20-50 times faster than in slug flow. Despite its superior mass transfer, however, the phase separation challenges of this flow regime have limited the usage of micro-extractors that operate in this regime.

Previous efforts to improve LLE have focused principally on improving the efficiency of liquid-liquid mixing (for example, via micro-extractors), with comparatively little attention given to the separation stage. Using efficient capillary-based micro-separators and/or integrating them with upstream micro-extractors, however, provides another strategy for the improvement of the efficiency of the LLE process, particularly as applies to hydrometallurgy. Surface-based micro-separators (such as capillary-based micro-separator) capitalize on the dominance of interfacial forces over gravitational ones in micro-environments to achieve continuous liquid-liquid separation. More specifically, they leverage surface-wetting properties, capillary pressures, and micro-architecture to control and separate the laminar two-phase flow, as described herein. These micro-separators display higher process robustness than gravity separators such as mixer-settlers and substantially reduce the residence times to circumnavigate a major process bottleneck.

Among the most widely used micro-separators for hydrometallurgy and other applications is a space-tested membrane-based micro-separator. The device contains a porous hydrophobic membrane that is preferentially wetted by the organic phase. The wetting phase selectively passes through the membrane, while the capillary pressures generated in the membrane's narrow pores prevent the non-wetting phase from flowing through. Precise pressure control prevents the aqueous phase from passing across the membrane while ensuring the passage of all the organic fluid. The device has been integrated with different micro-mixer/micro-extractor devices for the separation of various metals. Despite the system's proven ability to separate slug flow regimes, the membrane's narrow pores with diameters between 0.1-2 μm render it particularly prone to fouling by insoluble solutes and gel formation. This drawback can impose major operational restrictions and require frequent membrane replacement, especially in the case of hydrometallurgical feeds (i.e., brine, e-waste leachate, and so on).

Another device, the slit-shaped micro-separator, has been used for hydrometallurgical liquid-liquid separation. The device houses two hydrophilic blocks on one side and two hydrophobic blocks on the other. The alike blocks are separated by a small slit spaced to allow the corresponding wetting phase to flow through while exerting a repelling capillary pressure on the non-wetting fluid. The capillary pressure between the slits can be more than twice the hydraulic pressure at the other outlet to prevent a breakthrough of the non-wetting phase. Previous work on this micro-separator, however, has shown that its performance deteriorated under a non-slug flow regime, hindering its usage with the highly efficient dispersed droplet flow regime.

Flow splitter micro-separators have also been used for the extraction of UO₂ via integration with a T-mixer micro-extractor. This simple micro-separator splits an incoming two-phase flow between two tubes having either hydrophobic or hydrophilic wetting properties. Although effective, this device has been generally utilized only for low throughput processes, due to lack of throughput scalability.

Furthermore, while the membrane and slit micro-separators achieved some success in other applications, the effective range of flow rates for these devices when used for hydrometallurgical processes has not exceeded 10 mL/min. Without being bound to any particular theory, it is currently believed that this is caused by the highly viscous nature of hydrometallurgical aqueous feeds and organic solvents, which significantly deteriorates the performance of capillary-driven separators via increasing the pressure drops and viscous forces in the system.

### B. Methods of the Disclosure

To address the above-mentioned concerns, the disclosed fluid phase separators of the present disclosure were developed. In some aspects of the disclosure, a fluid phase separator was developed as described herein, such as the fluid phase separator 200. While phase separator 200 is indicated for illustrative purposes, it will be appreciated that the other phase separators disclosed herein may also be used alongside or in lieu of the fluid phase separator 200. The monolithic nature and design of the separator removes the need for internal sealing, fouling-prone membrane, and surface treatment. Additionally, the monolithic fluid phase separator can be used on a flexible scale, and can be readily scaled up, by increasing the number of phase separator units, to improve overall system throughput. The monolithic fluid phase separator disclosed herein also can function well in the highly efficient dispersed droplet flow regime. Furthermore, the monolithic fluid phase separator can be manufactured completely from recyclable materials, as disclosed herein and may therefore be recyclable.

In aspects of the disclosure, the fluid phase separator can be integrated with an upstream coiled flow inverter (CFI) to intensify lithium extraction from synthetic brine using TBP/FeCl₃/DS. This application serves as a model case for broader hydrometallurgical processes. In examples described herein, the extraction and separation performance of the CFI-phase separator system, in addition to its power requirement, were assessed under the optimum conditions for lithium extraction and different flow patterns and conditions. The manufacturing aspects and functionality of this system render it particularly suited for earth-bound modular LLE applications, in addition to in-situ resource extraction for the space-industry.

Because the separation mechanism of the fluid phases separators disclosed herein depends on the capillary pressure exerted on the phase with the highest contact angle with the walls of the capillary cells (that is, the non-wetting phase) compared to the capillary pressure exerted on the phase or phases with lower contact angles with the walls of the capillary cells (that is, the wetting phase or phases), the phase separation devices disclosed herein can separate a variety of fluid mixtures, provided that the fluids are both immiscible and have a different angle of contact with the boundaries of the capillary cells of the separator.

In a generalized aspect of the disclosure, the separation process can be utilized for a mixture of two or more fluids that are immiscible in one another, and which have interfacial tension and viscosities amenable for physical separation in any one of the fluid phase separators disclosed herein.

In some aspects of the disclosure, the fluid mixtures separated may be liquid-liquid mixtures, including mixtures of aqueous liquids and organic liquids. In some aspects of the disclosure, the aqueous liquid can comprise water, alcohol, or any combination thereof. In some aspects of the disclosure, the organic liquids can comprise an organic solvent, including cyclohexane, an oil, an ionic liquid, or any combination thereof. In some aspects of the disclosure, the liquid-liquid fluid mixture may comprise a first aqueous liquid and a second aqueous liquid. In some aspects of the disclosure, the liquid-liquid mixture may comprise a first organic liquid and a second organic liquid. In some aspects of the disclosure, both fluids may have different physical properties, such as viscosity and density.

In some aspects of the disclosure, the fluid mixtures separated may be liquid-gas mixtures. The liquid may be any of the aqueous or organic liquids described herein, or a combination thereof. In some aspects of the disclosure, the gas can be air, oxygen, carbon dioxide (CO₂), or any combination thereof. In aspects of the disclosure directed to the separation of CO₂ from a fluid phase, the CO₂ can be absorbed using an amine solvent.

In some aspects of the disclosure, the fluid mixture may comprise a metallic brine. The metallic brine may comprise one or more metallic elements suspended or dissolved in a liquid phase. The liquid phase can comprise an extractant, such as di(2-ethylhexyl)phosphoric acid (or D2EHPA), Versatic 10 (vinyl neodecanoate), CYANEX® 923 (liquid phosphine oxide), ALIQUAT® 336 (tricaprylylmethylammonium chloride), tributyl phosphate, or any combination thereof. The liquid phase may also comprise a coextractant if needed, such as ferric chloride. The liquid phase may also comprise a diluent, such as methyl isobutyl ketone (or MIBK), kerosene, 2-octanol, or any combination thereof. The metallic element may comprise an alkali metal, an alkaline metal, a transition metal, a rare earth element, an actinide, or a combination thereof. In some aspects of the disclosure, the metallic element is present in the form of a salt of the metallic element. In a specific aspect of the disclosure, the metallic element is lithium, cobalt, magnesium, uranium, iron, or a rare earth element.

In some aspects of the disclosure, additional metallic elements and/or metallic salts can be extracted using the methods disclosed herein. The metallic elements can include actinides, transition metals. In specific aspects, the metallic element can be one of lithium, cobalt, magnesium, uranium, iron, copper, nickel, gold, magnesium, aluminum, boron, calcium, strontium, sodium, potassium, and/or a rare earth element.

Additional parameters beyond the wetting angle of the phases of any mixture passed through the fluid phase separator may affect the separation of the phases and the flow rate of the fluid phases through the separator. In some aspects of the disclosure, the devices disclosed herein may be used to separate fluid phases for which viscosity and/or interfacial tension is a limiting factor on the ability of the phases to separate within the capillary cells, and for the flow rate of the fluid mixtures through the fluid phase separators. In such aspects, the fluid phase separator, the components thereof, or any of the fluid phases of which the mixture is comprised may be heated or cooled to change the contact angle and/or the viscosity of the fluid phases. In some aspects of the disclosure, the devices disclosed herein may be operated under a range of elevated or reduced pressures, including pressures below atmospheric pressure such as partial vacuum, and pressures above atmospheric pressure, including pressures up to the supercritical pressure range.

### VI. Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A fluid phase separator, comprising: one or more capillary cells, each capillary cell comprising a first plate, a corresponding second plate spaced apart from the first plate, and a gap between the first plate and the second plate; an inlet in fluid communication with a first end of the one or more capillary cells; a first outlet in fluid communication with a second end of the one or more capillary cells; and a second outlet in fluid communication with the second end of the one or more capillary cells, wherein each first plate is disposed at an angle to the corresponding second plate, such that a distance between each first plate and the corresponding second plate is greater at a first side of each capillary cell than at a second side of each capillary cell, and wherein the fluid phase separator is configured to (i) admit a first mixture of at least a first fluid and a second fluid at a first concentration, (ii) split the first mixture into a second mixture of the first fluid and the second fluid at a second concentration and a third mixture of the first fluid and the second fluid at a third concentration, and (iii) emit the second mixture and the third mixture from the first outlet and the second outlet respectively.

Example 2. The fluid phase separator of any example herein, particularly example 1, wherein the one or more capillary cells are in communication with the inlet at the first end of the one or more capillary cells and also in communication with the first outlet and the second outlet at the second end of the one or more capillary cells.

Example 3. The fluid phase separator of any example herein, particularly example 2, comprising a plurality of the one or more capillary cells and wherein capillary cells of the plurality are arranged in a cylindrical configuration, spaced circumferentially apart from one another such that the first side of each capillary cell is positioned towards a periphery of the cylindrical configuration and the second side of each capillary cell is positioned towards the center of the cylindrical configuration.

Example 4. The fluid phase separator of any example herein, particularly example 3, further comprising a first collector positioned between the second end of the plurality of the one or more capillary cells and the first outlet.

Example 5. The fluid phase separator of any example herein, particularly example 4, further comprising a second collector disposed radially outwards from the first collector and positioned between the second end of the plurality of the one or more capillary cells and the second outlet.

Example 6. The fluid phase separator of any example herein, particularly examples 1-5, wherein the first fluid is an aqueous phase and the second fluid is an organic phase.

Example 7. The fluid phase separator of any example herein, particularly example 6, wherein the second fluid comprises an oil.

Example 8. The fluid phase separator of any example herein, particularly example 6, wherein the second fluid comprises an organic solvent.

Example 9. The fluid phase separator of any example herein, particularly examples 1-5, wherein the first fluid comprises an extractant and a metallic element, and wherein the second fluid comprises a diluent.

Example 10. The fluid phase separator of any example herein, particularly example 9, wherein the metallic element is lithium, cobalt, magnesium, iron, copper, nickel, gold, magnesium, aluminum, boron, calcium, strontium, sodium, potassium, uranium, a rare earth element, or a combination thereof.

Example 11. The fluid phase separator of any example herein, particularly example 9, wherein the extractant comprises D2EHPA, vinyl neodecanoate, liquid phosphine oxide, tricaprylylmethylammonium chloride, Tributyl Phosphate, or any combination thereof.

Example 12. The fluid phase separator of any example herein, particularly example 9, wherein the diluent comprises MIBK, kerosene, 2-octanol, or any combination thereof.

Example 13. The fluid phase separator of any example herein, particularly examples 1-5, wherein the first fluid is a gas and the second fluid is a liquid.

Example 14. The fluid phase separator of any example herein, particularly examples 1-13, wherein a surface of the first plate and/or a surface of the second plate is at least partially covered with a hydrophilic coating.

Example 15. The fluid phase separator of any example herein, particularly example 14, wherein the hydrophilic coating is applied in a gradient, such that a first lateral portion of the first plate and/or the second plate has a higher hydrophilicity than a second lateral portion of the first plate and/or the second plate.

Example 16. The fluid phase separator of any example herein, particularly examples 1-13, wherein a surface of the first plate and/or a surface of the second plate at least partially covered with a hydrophobic coating.

Example 17. The fluid phase separator of any example herein, particularly example 16, wherein the hydrophobic coating is applied in a gradient, such that a first lateral portion of the first plate and/or the second plate has a higher hydrophobicity than a second lateral portion of the first plate and/or the second plate.

Example 18. The fluid phase separator of any example herein, particularly examples 1-17, wherein the first plate and the second plate of the one or more capillary cells are independently made of a glass material.

Example 19. The fluid phase separator of any example herein, particularly examples 1-17, wherein the first plate and the second plate of the one or more capillary cells are independently made of a polymer material, a metal material, a ceramic material, or any combination thereof.

Example 20. The fluid phase separator of any example herein, particularly examples 1-19, wherein the distance between the first plate and the second plate at the first side of the capillary cell is at least a factor of 1.2 greater than the distance between the first plate and the second plate at the second side of the capillary cell.

Example 21. The fluid phase separator of any example herein, particularly examples 1-20, wherein the distance between the first plate and the second plate at the first side of the capillary cell is at least a factor of 1.8 greater than the distance between the first plate and the second plate at the second side of the capillary cell.

Example 22. The fluid phase separator of any example herein, particularly examples 1-21, wherein the distance between the first plate and the second plate at the first side of the capillary cell is 2 mm or less.

Example 23. The fluid phase separator of any example herein, particularly examples 1-22, wherein the distance between the first plate and the second plate at the first side of the capillary cell is no more than a factor of 50 greater than the distance between the first plate and the second plate at the second side of the capillary cell.

Example 24. The fluid phase separator of any example herein, particularly examples 1-23, wherein the first plate is disposed at an angle relative to the second plate that ranges from 0.5° to 20°.

Example 25. The fluid phase separator of any example herein, particularly examples 1-22, wherein the fluid phase separator does not comprise a filter.

Example 26. An array of phase separators, comprising: a first phase separator, comprising a flow plate, a cover plate, a first inlet, a first outlet, and a second outlet, and an array of columns formed on the flow plate and disposed between the first inlet and the first outlet and the second outlet; and a second phase separator in fluid communication with the first phase separator, comprising a second inlet, a third outlet, a fourth outlet, and an array of capillary cells circumferentially arranged around a centerline axis and positioned between the second inlet and the third and fourth outlets; wherein each capillary cell of the second phase separator comprises a first interior surface, a second interior surface oriented at an angle relative to the first interior surface, and a gap positioned between the first interior surface and the second interior surface, wherein the first phase separator is configured to receive a first fluid mixture with a first composition and produce a first product stream with a second composition and a second product stream with a third composition, and wherein the second phase separator is configured to receive a second fluid mixture with a fourth composition and produce third product stream with a fifth composition and a fourth product stream with a sixth composition.

Example 27. The array of phase separators of any example herein, particularly example 26, wherein the first phase separator is positioned upstream of the second phase separator.

Example 28. The array of phase separators of any example herein, particularly example 27, wherein the second fluid mixture received by the second phase separator comprises the first product stream from the first phase separator.

Example 29. The array of phase separators of any example herein, particularly example 28, wherein the second fluid mixture further comprises one or more additional fluids or solutes.

Example 30. The array of phase separators of any example herein, particularly example 28, wherein the second composition and the fourth composition are the same.

Example 31. The array of phase separators of any example herein, particularly example 26, wherein the second phase separator is positioned upstream of the first phase separator.

Example 32. The array of phase separators of any example herein, particularly example 31, wherein the first fluid mixture received by the first phase separator comprises the third product stream from the second phase separator.

Example 33. The array of phase separators of any example herein, particularly example 32, wherein the first fluid mixture further comprises one or more additional fluids or solutes.

Example 34. The array of phase separators of any example herein, particularly example 32, wherein the fifth composition and the first composition are the same.

Example 35. The array of phase separators of any example herein, particularly examples 26-34, wherein a distance between the first interior surface and the second interior surface at a radially most outward portion of the capillary cell is 2 mm or less.

Example 36. The array of phase separators of any example herein, particularly examples 26-35, wherein the second phase separator comprises at least 30 capillary cells.

Example 37. The array of phase separators of any example herein, particularly examples 26-35 wherein the column array of the first phase separator comprises a plurality of columns arranged such that an average spacing between the columns at a first lateral side of the flow plate is greater than an average spacing between the columns disposed towards a second lateral side of the flow plate.

Example 38. A fluid phase separator comprising: a cylindrical body having an external wall, an inlet end, an outlet end, a central column extending between the inlet end and the outlet end along a longitudinal axis, and an internal cavity defined by the external wall and the central column; a plurality of vanes circumferentially disposed around the central column, extending between the inlet end and the outlet end, and extending from the central column to an interior surface of the external wall; a fluid inlet positioned at the inlet end; and a first fluid outlet and a second fluid outlet positioned at the outlet end of the cylindrical body; wherein the plurality of vanes divides the internal cavity into a radially and axially extending plurality of capillary cells, and wherein the plurality of capillary cells is configured to at least partially separate a mixture of two or more fluid phases.

Example 39. The fluid phase separator of any example herein, particularly example 38, further comprising a first collector aligned with the central column and positioned between the plurality of capillary cells and the first fluid outlet, wherein the first collector is configured to receive a first product stream from the capillary cells and convey the first product stream to the first fluid outlet.

Example 40. The fluid phase separator of any example herein, particularly example 39, further comprising a second collector positioned radially outwards from the first collector and positioned between the plurality of capillary cells and the second fluid outlet, wherein the second collector is configured to receive a second product stream from the capillary cells and convey the second product stream to the second fluid outlet.

Example 41. The fluid phase separator of any example herein, particularly examples 38-40, wherein the plurality of vanes comprises a plurality of glass slides, and wherein the external wall and the central column comprise a plurality of notches configured to receive and circumferentially space apart the plurality of glass slides.

Example 42. The fluid phase separator of any example herein, particularly examples 38-40, wherein the plurality of vanes comprises a polymer material.

Example 43. The fluid phase separator of any example herein, particularly example 42, wherein the plurality of vanes is integrally formed with the external wall and the central column.

Example 44. The fluid phase separator of any example herein, particularly example 43, wherein the fluid phase separator comprises a single integrally formed body.

Example 45. The fluid phase separator of any example herein, particularly example 44, wherein the fluid phase separator is additively manufactured.

Example 46. The fluid phase separator of any example herein, particularly examples 38-45, further comprising a hydrophilic coating, a hydrophobic coating, or any combination thereof disposed on one or more vanes of the plurality of vanes.

Example 47. The fluid phase separator of any example herein, particularly example 46, wherein the hydrophilic coating comprises perfluoropolyether, hydrogel, or any combination thereof.

Example 48. The fluid phase separator of any example herein, particularly example 46, wherein the hydrophobic coating comprises self-assembling monolayers, silanes, polydimethylsiloxane, or any combination thereof.

Example 49. The fluid phase separator of any example herein, particularly examples 38-48, the maximum spacing between two adjacent vanes at a radially outermost portion of a capillary cell is 2.0 mm or less.

Example 50. An assembly, comprising: a first fluid phase separator according to any of any example herein, particularly examples 38-49; and a second fluid phase separator according to any of any example herein, particularly examples 36-47.

Example 51. The assembly of any example herein, particularly example 50, wherein the first fluid phase separator and the second fluid phase separator are arranged in series with the first fluid phase separator.

Example 52. The assembly of any example herein, particularly example 50, wherein the first fluid phase separator and the second fluid phase separator are arranged in parallel with the first fluid phase separator.

Example 53. A fluid phase separator, comprising: a first plate; a second plate spaced apart from the first plate to define a channel extending between the first plate and the second plate; and a fixed housing that receives the first plate and the second plate, and defines an inlet and an outlet of the channel; wherein the first plate and the second plate are oriented at a first angle relative to one another, such that a distance between the first plate and the second plate is greater at a first side of the channel than the distance between the first plate and the second plate at a second side of the channel, and wherein, when a mixture of insoluble fluids passes through the channel from the inlet to the outlet, the mixture of insoluble fluids is separated into a first fluid with a first composition and a second fluid with a second composition.

Example 54. The fluid phase separator of any example herein, particularly example 53, further comprising a shim disposed between the first plate and the second plate, such that a width of the channel varies along a length of the channel.

Example 55. The fluid phase separator of any example herein, particularly examples 53-54, wherein a hydrophilic coating is disposed on at least one of the first plate or the second plate comprises, the hydrophilic coating comprising perfluoropolyether, hydrogel, or any combination thereof.

Example 56. The fluid phase separator of any example herein, particularly examples 53-54, wherein a hydrophobic coating is disposed on at least one of the first plate or the second plate comprises, the hydrophobic coating comprising self-assembling monolayers, silanes, polydimethylsiloxane, or any combination thereof.

Example 57. The fluid phase separator of any example herein, particularly examples 53-56, wherein the first plate and the second plate are glass slides.

Example 58. The fluid phase separator of any example herein, particularly examples 53-57, further comprising a seal disposed between the first plate or the second plate and the fixed housing.

Example 59. A method of separating two or more fluid phases, comprising: introducing a mixture comprising two or more fluid phases to the fluid phase separator of any example herein, particularly examples 1-25, 38-49, or 53-58, the assembly of any example herein, particularly examples 48-50, or the array of fluid phase separators of any example herein, particularly examples 24-35; passing the mixture through a capillary cell of the fluid phase separator, the assembly, or the array of fluid phase separators with a narrow side portion and a wide side portion and providing a variable angle of contact with the fluid; separating a first fluid phase of the two or more fluid phases having the highest contact angle with the capillary cell towards the wide side portion of the capillary cell by capillary motion; separating the fluid phases with lower contact angles with the capillary cell than the first fluid phase towards the narrow side portion of the capillary cell; collecting the first fluid phase; and collecting the remaining fluid phases separately from the first fluid phase.

Example 60. The method of any example herein, particularly example 59, wherein at least 50% percent of the first fluid phase is separated from the mixture and collected.

Example 61. The method of any example herein, particularly example 59, further comprising passing one or more of the collected phases through a second phase separator, fluid phase separator of any example herein, particularly examples 1-23, 36-47, or 51-56, the assembly of any example herein, particularly examples 50-52, or the array of phase separators of any example herein, particularly examples 26-37.

Example 62. The method of any example herein, particularly examples 59-61, further comprising heating or cooling one or more of the phases in the mixture of phases to change a viscosity and/or the contact angle of that phase.

Example 63. The method of any example herein, particularly examples 58-61, wherein the mixture is passed through the capillary cell without assistance of gravity.

Example 64. The method of any example herein, particularly examples 58-61, wherein the mixture comprises a lithium brine, and wherein the method further comprises contacting the brine with an extractant in a coiled flow inverter.

Example 65. An assembly comprising: a coiled flow inverter, and the fluid phase separator of any example herein, particularly examples 1-25, 38-49, or 53-58, the assembly of any example herein, particularly examples 48-50, or the array of fluid phase separators of any example herein, particularly examples 24-35, positioned downstream of and in fluid communication with the coiled flow inverter.

Example 66. The fluid phase separator of any example herein, particularly examples 1-25, 38-49, or 53-58, the assembly of any example herein, particularly examples 48-50 or 65, the array of fluid phase separators of any example herein, particularly examples 24-35, wherein the fluid phase separator, the assembly, or the array of fluid phase separators, is recyclable.

### VII. EXAMPLES

### Example 1: Lithium Brine Extraction

In this example, a monolithic fluid phase separator was developed and used to evaluate the use of the separator in lithium separation/isolation.

A simulated lithium brine was prepared using lithium chloride (LiCl) (>99.7%), magnesium chloride hexahydrate (MgCl₂·6H₂O) (≥99%), sodium chloride (NaCl) (>99%), and potassium chloride (KCl) (>99%). All salts were purchased from Fisher Chemical. The salts were dissolved in deionized water to yield ionic mass concentrations of 0.35 g/L Lit, 86 g/L Mg²⁺, 1.67 g/L Na⁺, and 0.87 g/L K⁺. Subsequently, anhydrous ferric chloride (FeCl₃) co-extractant (Thermo Scientific, 98%) was added to the aqueous phase to obtain the optimum Fe:Li molar ratio of 1.3:1. The brine's pH was measured at (pH value) after the addition of FeCl₃ using a pH meter at room temperature. The organic phase consisted of the extractant tributyl phosphate (TBP) (MilliporeSigma, ≥99%) and the diluent diethyl succinate (DS) (Sigma-Aldrich, ≥99%). These solvents were respectively mixed at 30% and 70% v/v to ensure the highest lithium extraction and selectivity. All chemicals were used without additional purification. The densities, viscosities, and interfacial tension of the simulated brine and organic phase before and after extraction are shown in Table 1.

TABLE 1
Fluid properties of the organic and aqueous system: Synthetic Brine-TBP/DS

| | | | Dynamic | Interfacial |
|---|---|---|---|---|
| | | Density | Viscosity | Tension |
| | Compound(s) | (g/mL) | (cP) | (Liquid-Liquid) |
| Initial | TBP/DS | 1.008 g/mL | 2.75 cP | 11.9 mN/m |
| | | at RT | at 25° C. | at RT |
| | Synthetic | 1.254 g/mL | 5.44 cP | |
| | Brine | at RT | at 25° C. | |
| At | TBP/DS | 1.017 g/mL | 3.08 cP | 12.8 mN/m |
| Equilibrium | | at RT | at 25° C. | at RT |
| | Synthetic | 1.252 g/mL | 5.2 cP | |
| | Brine | at RT | at 25° C. | |

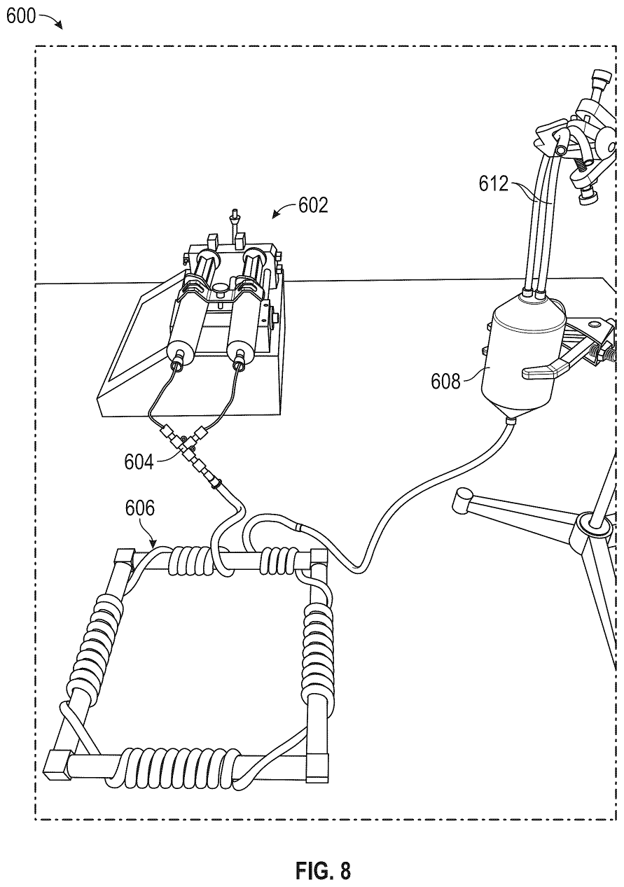

The setup 600 for the solvent extraction and phase separation evaluations is shown in FIG. 8. A pump 602, such as PHD 2000 syringe pump was used to inject both fluids using 50 mL syringes. The two phases were introduced via two Tefzel™ tubes (L=10 cm, ID=1 mm, OD=1.59 mm) to a PEEK cross-shaped T-mixer with ID=0.5 mm. The aqueous phase was consistently fed to the T-mixer 604 in the direction of flow, while the organic phase was orthogonal to it. A Tefzel™ tube (L=2.5 cm, ID=1.59 mm, OD-3.18 mm) connected the T-mixer outlet to the Coiled-Flow Inverter (CFI) 606. The CFI 606 was constructed as described below to intensify lithium extraction. After exiting the CFI 606, the two-phase flow was introduced to the 3D-printed phase separator 608 via a Tygon® tube (L=30 cm, ID=2.79 mm, OD=4.52 mm) to achieve capillary-based continuous separation. A detailed description of the architecture and manufacturing technique of an exemplary phase separator 608 is presented below. Finally, the separated phases were directed out of the phase separator to the collection vials via two tubes 612, such as Tygon® tubes connected to the aqueous and organic outlet ports (L=15 cm, ID=2.79 mm, OD=4.52 mm).

### Construction of CFI

The CFI was fabricated in-house by coiling a flexible and transparent PVC tube around a 3D-printed PETG square structure produced by a Prusa i3 MK3S+ 3D printer. The organic-wetted PVC tube had a length L=3.11 m, with an internal diameter dᵢ=3.175 mm, and an outer diameter dₒ=6.35 mm. The 3D-printed square structure consisted of 4 rods with a side length of 20 cm and a rod diameter dᵣ=1.5 cm. The coil diameter (d_{c}), a parameter denoting the distance between the centers of the PVC tube on opposite sides of the rod was d_{c}=2.135 cm, with a corresponding curvature ratio

$$λ = \frac{{d}_{c}}{{d}_{i}} = 6.72 .$$

the low λ value increased the secondary flow radial mixing in the CFI in the form of stronger Dean vortices as reflected by higher Dean numbers

$$( De = Re \sqrt{\frac{1}{λ}} ) .$$

Moreover, since lateral mixing in the CFI is further enhanced by the change of centrifugal force direction after flow inversion at each 90° bend, the PVC tube was bent 4 times around the square's corners, while maintaining a similar coil length between consecutive bends. Finally, the CFI's straight inlet and outlet tube sections had a length of 15 cm each. The CFI's characteristics remained constant throughout the evaluations.

### Architecture and Manufacturing of the 3D-Printed Phase Separator

The 3D-printed phase separator enclosed 36 individual sloped channels arranged radially for parallel operation, such as previously illustrated in FIGS. 3A-3D. The channels' architecture was identical, with “floor” and “ceiling” surfaces angled at 6.3°, leading to minimum and maximum sides' depths of 530 μm and 2000 μm, respectively, and a channel width of 14.6 mm. The cone-like inlet manifold ensured the even distribution of the two-phase flow to all 36 channels while minimizing the regions of fluid stagnation and promoting coalescence. The cone was angled at 73.8° relative to the horizontal plane to maintain structural integrity during 3D printing and was supported by 4 symmetrical beams reaching the MMS' outer structure.

The two-phase flow was subsequently separated in the sloped channels extending upwards for 55.7 mm, with the wetting and non-wetting fluids respectively directed toward the smaller and larger sides of the channels. At the end (top) of each sloped channel, the separated fluids exited via two outlets located on opposite lateral sides of the channel. The outlets' positions and geometries within a sloped channel are shown in FIG. 4. Finally, similar fluid phases exiting from the 36 channels were recombined in an outlet manifold and subsequently directed out of the device via their respective ports. The phase separator had a total internal flow volume of 47.7 mL, with an effective separation volume (only slope channels) of 37 mL. The circular footprint of phase separator had a diameter of 45.3 mm, and a total vertical length of 105.7 mm. Given its monolithic nature, the device did not require any form of internal scaling and offered a “plug-and-play” operational capability.

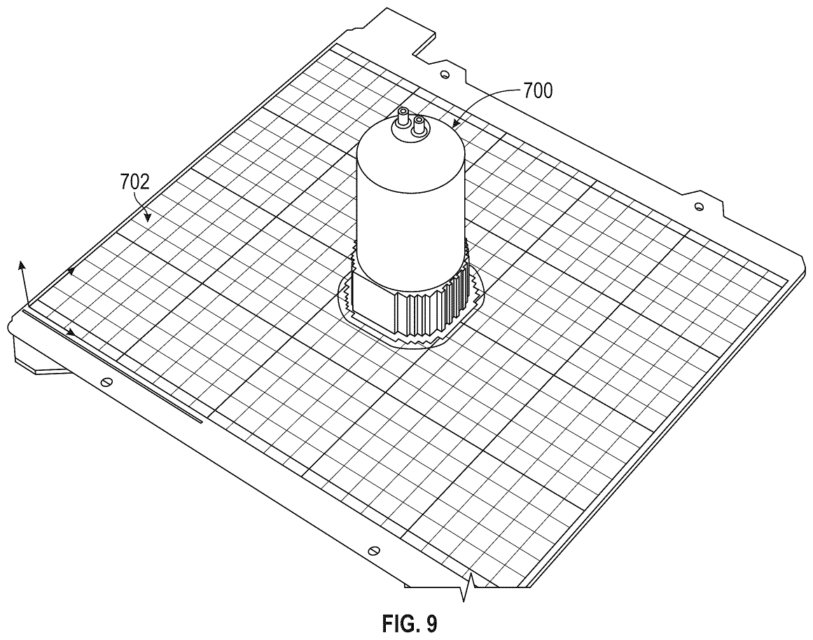

The phase separator's architectural features were tailored to be effectively producible by low-cost commercial 3D printers. The device was thus successfully printed using Fused Deposition Modelling (FDM) technique on a Prusa i3 MK3S+ 3D printer. The printer was equipped with the standard 0.4 mm nozzle. PETG was the print material of choice given its chemical compatibility with the selected solvents and desirable surface-wetting properties. The PETG filament had a diameter of 1.75 mm, and no material or surface treatment steps were carried out before or after printing. The phase separator design was imported into the PrusaSlicer 2.4.2 software as a binary STL file with 18484 triangle elements. The device 700 was then vertically positioned with its inlet facing the build plate 702 as shown in FIG. 9. Subsequently, support material was exclusively added to the phase separator's exterior while avoiding any obstruction to the interior flow volume. The infill density was set to 15% and the print layer height to 0.15 mm. These settings ensured good print quality within a reasonable print time. Prusa's recommended temperature settings for PETG were used, with a nozzle temperature of 230° C. for the first layer, and 240° C. for the other layers. The bed temperature was 85° C. for the first layer, and 90° C. for the other layers. The print time was estimated at 17 hours and 17 minutes, requiring 90.71 grams of filament. The calculated filament cost of the print was 2.52$. After printing, the exterior support material was manually removed, and the device was ready to use. The phase separator can also be 3D-printed using multiple polymers or metals depending on the desired surface properties, and the chemical, mechanical, and thermal requirements of the process.

The viscosities of the simulated lithium brine and the organic mixture were measured using an ARG2 rheometer. The interfacial tensions between the phases pre- and post-extraction were determined via a pendant drop tensiometer. Moreover, the equilibrium contact angle formed between the 3D-printed PETG surface of the device, the wetting phase (e.g., organic), and the non-wetting phase (e.g., aqueous) was also determined on the same instrument. All measurements were done at room temperature. Inductively Coupled Plasma-Optical Emission Spectroscopy (ICP-OES) was used to measure the concentrations of Li⁺ and Fe³⁺ in the simulated brine before and after extraction. Since the concentrations of Mg²⁺, Na⁺ and K⁺ in the brine remained very high after extraction, large measurement errors were found when attempting to directly measure their amounts in brine samples. For that reason, the organic samples obtained after extraction were stripped using 2M HCl solution under an aqueous: organic volumetric ratio of 2:1. One stripping stage was sufficient to extract all the metals of interest from the organic phase. Subsequently, the concentrations of Mg²⁺, Na⁺ and K⁺ in the HCL solution were measured in ICP-OES. The concentrations of these metals in the organic phase and the brine were then obtained by mass conservation.

### Solvent Extraction in Micromixer and Coiled-Flow Inverter (CFI)

Lithium extraction from simulated brine via TBP/DS was initially investigated in the T-mixer alone, then after attaching the CFI. This was done to evaluate the contribution of both components to mass transfer under different fluidic conditions. To ensure the highest extraction efficiency and selectivity, TBP/DS were respectively mixed at 30% and 70% v/v, with FeCl₃ CO-extractant added to the brine at 1.3:1 Fe:Li molar ratio. The total volumetric flow rates (Qin) were 20, 30, 40, 50, and 60 mL/min. The resulting extraction residence times (Text) in the CFI were 75, 50, 37.5, 30, and 25 s, respectively, with substantially smaller Text in the T-mixer alone (<0.16 s). The inlet aqueous: organic volumetric flow ratio (Qin:Qu) was set to 1:1, which has been shown to maximize extraction performance while minimizing solvent consumption. All experiments were carried out at room temperature. After allowing the flow sufficient time to develop and stabilize in the CFI, samples were collected for 30 seconds. Immediately after two-phase separation in the collection vials, aqueous and organic samples were withdrawn for ICP-OES measurements. The two-phase flow at the CFI inlet, outlet, and corners were photographed to study the impact of flow patterns on extraction and subsequent separation.

Knowing that Q_{aq}ⁱⁿ:Q_{org}ⁱⁿ=1:1, the extraction performance was assessed based on the following parameters as described by Equations 13-15:

$${E}_{M} \% = \frac{{[ M ]}_{aq , in} - {[ M ]}_{aq , out}}{{[ M ]}_{aq , in}} * 100 = \frac{{[ M ]}_{org , out}}{{[ M ]}_{aq , in}} * 100 \qquad ( Equation 13 )$$

With E_{M}% denoting the extraction efficiency of metal species M.

$${D}_{M} = \frac{{[ M ]}_{aq , in} - {[ M ]}_{aq , out}}{{[ M ]}_{aq , out}} = \frac{{[ M ]}_{org , out}}{{[ M ]}_{aq , out}} \qquad ( Equation 14 )$$

With D_{M} representing the distribution ratio of metal species M between the effluent phases.

$${β}_{Li / M} = \frac{{D}_{Li}}{{D}_{M}} = \frac{{[ Li ]}_{org , out}}{{[ Li ]}_{aq , out}} * \frac{{[ M ]}_{aq , out}}{{[ M ]}_{org , out}} \qquad ( Equation 15 )$$

With β_{Li/M} being the separation factor of lithium with respect to metal species M.

[M]_{aq,in} and [M]_{aq,out} represent the concentrations of a given metal in the aqueous inlet and outlet streams, respectively, and [M]_{org,in} and [M]_{org,out} their concentrations in the organic phase.

The extraction performances of the T-mixer and CFI were also evaluated relative to equilibrium levels under the existing operating conditions; Q_{aq}ⁱⁿ:Q_{org}ⁱⁿ=1:1, room temperature and ambient pressure. The equilibrium metal concentrations were determined in ICP-OES after intensely mixing and separating an equal volume of simulated brine and TBP/DS. E_{M/Eq}% was thus defined as the extraction efficiency of metal species M relative to the mass transfer limit at equilibrium (Equation 16):

$${E}_{M / Eq} \% = \frac{{[ M ]}_{aq , in} - {[ M ]}_{aq , out}}{{[ M ]}_{aq , in} - {[ M ]}_{aq , out / eq}} * 100 = \frac{{[ M ]}_{org , out}}{{[ M ]}_{org , out / eq}} * 100 \qquad ( Equation 16 )$$

With [M]_{aq,out/eq} and [M]_{org,out/eq} representing the concentration of metal species M in the aqueous (raffinate) and organic (extract) outlets at equilibrium.

### Phase Separation in the 3D-Printed Phase Separator

The two-phase flow exiting the CFI was separated in the vertically positioned phase separator. The capillary-driven, membrane-free, continuous, and density-independent separation was evaluated under the same Qₜₒₜ^{it}=20, 30, 40, 50, and 60 mL/min and Q_{aq}ⁱⁿ:Q_{org}ⁱⁿ=1:1 as the extraction tests. The 3D-Printed PETG surface of the device is inherently wetted by the organic phase without the need for surface treatment. Equal outlet flow rates from phase separator's aqueous and organic ports were ensured by fixing the heights of the outlet tubes (Q_{aq}^{out}:Q_{org}^{out}=1:1). The two phases were pre-equilibrated before the experimental runs so the separation performance is assessed independently from mass transfer. After introducing the two-phase flow in the phase separator and allowing sufficient time to reach steady operation, samples were collected at both the organic and aqueous outlet ports for 1 minute. Subsequently, the two-phase separation performance was assessed by measuring the volume purities of the samples collected at both ports in graduated cylinders. The volume purity percent of a given phase at its corresponding exit port was defined as shown in Equations 17 and 18 below:

$$Aqueous Phase Purity \% at the Aqueous \\ Exit Port ( V {\%}_{aq} ) = \frac{{V}_{aq}^{E - aq}}{{V}_{aq}^{E - aq} + {V}_{org}^{E - aq}} * 100 \qquad ( Equation 17 )$$

$$Organic Phase Purity \% at the Organic \\ Exit Port ( V {\%}_{org} ) = \frac{{V}_{org}^{E - org}}{{V}_{orq}^{E - org} + {V}_{aq}^{E - org}} * 100 \qquad ( Equation 18 )$$

With Vⱼ^{E-i} denoting the volume of phase j collected at the exit port assigned to phase i during collection time.

### Pressure Drop and Power Input

The pressure drop (ΔP) in the test-loop was determined using a low-pressure gauge with ±1.6% accuracy between 0-30 psi. The pressure drop was measured across the investigated Qin values for the T-mixer only, then after connecting the CFI, and finally the phase separator. Subsequently, the Power Input (Pᵢ) under different Qₜₒₜⁱⁿ for all 3 test-loop components was calculated using Equation 19:

$${P}_{i} [ W ] = {Q}_{tot}^{in} [ {m}^{3} / s ] * Δ P [ Pa ] \qquad ( Equation 19 )$$

The phase field function is used to track the interface boundary of the fluids and is advected by the velocity vector computed from the Navier-Stokes equation. Equations 20 and 21 show the phase field function. The term on the right-hand side of Equation 20 is a term used to minimize the free energy of the system. The phase field source term that originates from the surface tension at the free liquid surface is introduced into the Navier-Stokes equations and the contribution of surface tension is calculated from the chemical potential. Equation 22 shows the surface tension coefficient σ (in N/m) as a function of mixing energy density λ (in J/m3) and interface thickness ε (in m).

$$\frac{\partial ϕ}{\partial t} + u . ∇ ϕ = ∇ . \frac{γλ}{{ε}^{2}} ∇ ψ \qquad ( Equation 20 )$$

$$ψ = - ∇ . {ε}^{2} ∇ ϕ + ( {ϕ}^{2} - 1 ) ϕ + ( \frac{{ε}^{2}}{λ} ) \frac{\partial {f}_{ext}}{\partial ϕ} \qquad ( Equation 21 )$$

$$σ = \frac{2 \sqrt{2}}{3} \frac{λ}{ε} \qquad ( Equation 22 )$$

### Boundary Conditions

A no-slip boundary condition of u=0 at the solid boundaries was applied (as solid boundaries are stationary). A fully developed flow at fluid inlets is applied to ensure that the viscous effects due to shear stress between the fluid and solid channel walls are fully developed (with no entrance effects considered) with a pressure boundary outlet condition. The wetted wall boundary condition is used in the phase field to prescribe the contact angle of the wetting phase and specifies a mass flow of zero across the wall. The contact angle can be directly prescribed through the Young-Laplace equation.

Modeling multiphase flows is done at several scales. The range from the length scale may span about 8 orders of magnitude making it almost numerically impossible to resolve multiphase flows across the whole range possible using one mechanistic model. On smaller scales, separated multiphase flow models in COMSOL uses surface tracking methods to model phase boundary in detail. On larger scale, dispersed multiphase flow models in COMSOL are used to model the system using fields such as volume fractions. The phase field and level set methods are both field-based surface tracking methods where the iso-surface of either the level set or phase field functions represent the free fluid surface. The right-hand side of (Equation 20) offers the principal difference between the level-set and phase field methods. The right-hand side of (Equation 20) is used to prescribe compactness at the interface for the level set while the phase field method tries to minimize the free energy of the system. The phase field method introduces fourth-order terms and for practical reasons, an auxiliary dependent variable is defined in (Equation 21) to break (Equation 20) into second-order equations. The variables of the two-phase model are shown below:
ψ is the auxiliary dependent variable.
ϕ is the phase field function.
σ is the surface tension coefficient (N/m).
ε is the interface thickness (m), controls the thickness at the interface region.
λ is mixing energy density (J/m³).
Y is the reinitialization parameter and ensures that the gradient in the function is concentrated to the free surface over time.
ρ is the fluid density (kg/m3).
υ is the fluid velocity (m/s).
r_{C} is the mean surface curvature (m).
r₁, r₂ are the principal radii of curvature (m).
K is the Viscous stress tensor.

### Solvent Extraction in Micromixer and Coiled-Flow Inverter (CFI)

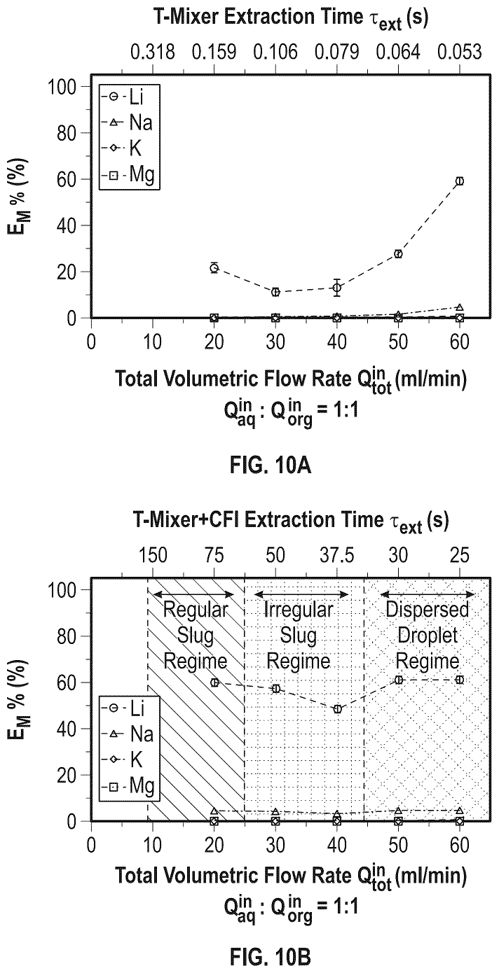

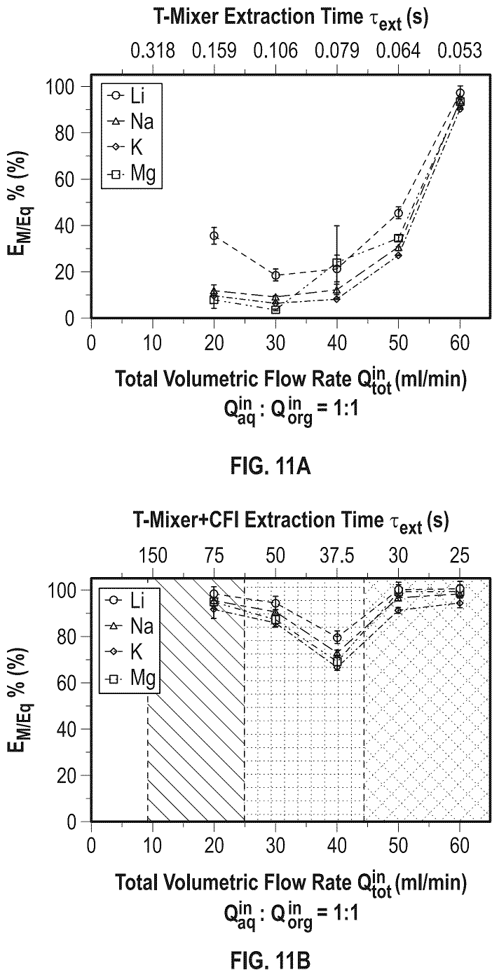

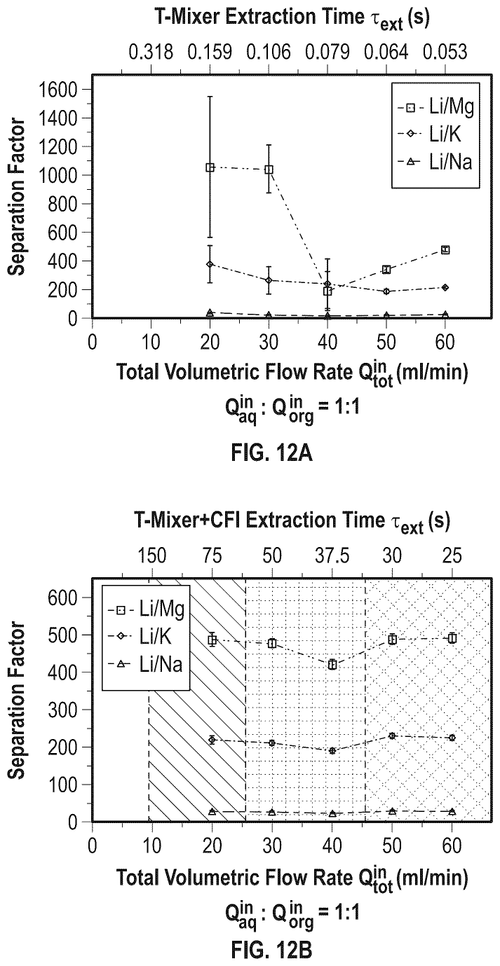

Lithium extraction from simulated brine via TBP/DS was studied in the T-mixer alone, then after attaching the CFI. This allowed assessing the individual contribution of these two components to mass transfer. The investigated total volumetric flow rates (Qₜₒₜⁱⁿ) were 20, 30, 40, 50, and 60 mL/min, leading to extraction residence times (τₑₓₜ) in the CFI of 75, 50, 37.5, 30, and 25 seconds, respectively. Substantially smaller τₑₓₜ were available in the T-mixer alone (<0.16 s). The inlet aqueous: organic volumetric flow ratio (Q_{aq}ⁱⁿ:Q_{org}ⁱⁿ) was set to the optimum ratio of 1:1. FIG. 10A-10B show the extraction efficiency of the different metal species (E_{M %}) at different Qₜₒₜⁱⁿ, under the T-mixer alone (FIG. 10A), then after connecting the CFI (FIG. 10B). The corresponding τₑₓₜ and the flow patterns observed in the CFI are also presented. The extraction efficiency of the metals relative to equilibrium (E_{M/Eq}%) is given in FIGS. 11A-11B, while FIGS. 12A-12B show the separation factor of lithium relative to Mg (β_{Li/Mg}), Na (β_{Li/Mg}), and K (β_{Li/K}). In particular examples, equilibrium (E_{M/Eq}%) is a function of one or more of concentration, temperature, and pressure, and can be determined using information known to those with ordinary skill in the art with the benefit of the present disclosure.

### Two-Phase Flow Regimes in the CFI

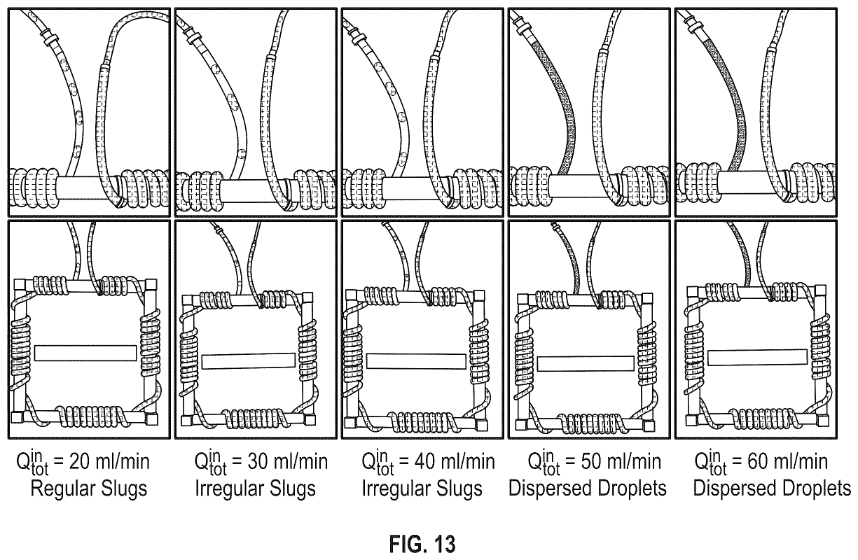

As shown in FIG. 13, three different flow patterns emerge in the CFI: regular slugs at Qₜₒₜⁱⁿ=20 mL/min, irregular slugs at Qₜₒₜⁱⁿ=30 and 40 mL/min, and dispersed droplets at Qₜₒₜⁱⁿ=50 and 60 mL/min. Initially, the wetting continuous phase TBP/DS is transparent and the non-wetting dispersed phase synthetic brine is yellow. At equilibrium, both solutions are pale yellow due to ferric iron transfer, with the brine slightly darker. The occurrence of the two-phase patterns is contingent on the ratios of the interfacial, inertial, and viscous forces in the extraction system, and they determine the rate and mechanism of mass transfer. At Qₜₒₜⁱⁿ=20 mL/min, small and uniform brine slugs of approximately 5 mm in length appeared throughout the CFI almost immediately after the T-mixer, suggesting a fluidic behavior dominated by interfacial forces. These surface tension forces lead to the spontaneous segmentation of the two-phase flow, and subsequent formation of the slugs, while preserving the stability of their interface by resisting the inertial and viscous stresses as they pass through the coiled tube.

The low Capillary

$$( Ca = \frac{μ v}{σ} )$$

### and Weber

$$( We = \frac{ρ {v}^{2} d}{σ} )$$

numbers of the organic and aqueous phases at 20 mL/min highlight the dominance of the interfacial force over the viscous and inertial forces in the CFI, respectively (Table 2).

TABLE 2
Fluidic Dimensionless Numbers in the CFI and T-Mixer

| | Qₜₒₜⁱⁿ | | | | | V_{De} |
|---|---|---|---|---|---|---|
| | (mL/min) | Ca | We | Re | De | (m/s) |
| Synthetic Brine | 20 | 0.009 | 0.148 | 16.118 | 6.216 | 0.004 |
| (Dispersed | 30 | 0.014 | 0.334 | 24.177 | 9.323 | 0.007 |
| Phase) | 40 | 0.018 | 0.593 | 32.236 | 12.431 | 0.011 |
| CFI | 50 | 0.023 | 0.927 | 40.295 | 15.539 | 0.016 |
| | 60 | 0.28 | 1.334 | 48.354 | 18.647 | 0.021 |
| TBP/DS | 20 | 0.005 | 0.119 | 21.874 | 8.435 | 0.006 |
| (Continuous | 30 | 0.008 | 0.268 | 32.811 | 12.653 | 0.011 |
| Phase) | 40 | 0.011 | 0.477 | 43.748 | 16.871 | 0.018 |
| CFI | 50 | 0.014 | 0.745 | 54.685 | 21.088 | 0.26 |
| | 60 | 0.016 | 1.073 | 65.622 | 25.306 | 0.35 |
| Synthetic Brine | 20 | 0.371 | 241.64 | 649.916 | — | — |
| (Dispersed | 30 | 0.556 | 542.394 | 974.874 | — | — |
| Phase) | 40 | 0.742 | 964.257 | 1299.832 | — | — |
| T-mixer | 50 | 0.927 | 1506.651 | 1624.790 | — | — |
| | 60 | 1.113 | 2169.578 | 1949.748 | — | — |
| TBP/DS | 20 | 0.220 | 193.774 | 882.009 | — | — |
| (Continuous | 30 | 0.330 | 435.992 | 1323.013 | — | — |
| Phase) | 40 | 0.439 | 775.096 | 1764.017 | — | — |
| T-mixer | 50 | 0.549 | 1211.088 | 2205.021 | — | — |
| | 60 | 0.659 | 1743.967 | 2646.26 | — | — |

While not shown in FIG. 13, a thin film of the wetting TBP/DS less than 25 μm in thickness is expected to be surrounding the brine slugs. An interfacial surface area of approximately 544 m²/m³ was calculated under this regime. As the flow rates are increased to 30 and 40 mL/min, an increase of the viscous and inertial forces relative to the interfacial force occurs in the T-mixer and CFI, reflected by higher Ca and We numbers. Slugs are formed only after few centimeters downstream from the T-mixer, with a jetting effect observed before that. This effect has been reported experimentally and numerically under higher Ca numbers. It is expected that as the flow experiences a sudden drop in velocity transitioning from the T-mixer (ID=0.5 mm) to the much larger CFI (ID=3.175 mm), the segmentation of the two-phase flow by the interfacial forces, which ultimately leads to the formation of slugs takes time to occur.

Furthermore, downstream in the CFI, the instability of the slugs' interface by inertial and viscous stresses as they pass through the tube results in their deformation and subsequent potential merging. As shown in FIG. 13, larger irregular slugs are observed in this regime, especially at the higher flow rate of 40 mL/min, where slug lengths exceeding 2 cm were observed. This disturbance of the slug structure results in a substantial decrease of the interfacial specific surface area available for mass transfer and an increase of diffusional lengths. A similar disruption of slug uniformity at high flow rates accompanied by a decrease in mass transfer was reported for the extraction of critical minerals from highly viscous feeds in CFI. Finally, at the highest Qin of 50 and 60 mL/min, a complete dispersion of brine in the continuous TBP/DS phase occurred in the form of microdroplets, with a total absence of slug structure along the length of the CFI (FIG. 13). This is the characteristic of a flow dominated by viscous and inertial forces reflected by high Ca and We numbers, respectively (Table 2).

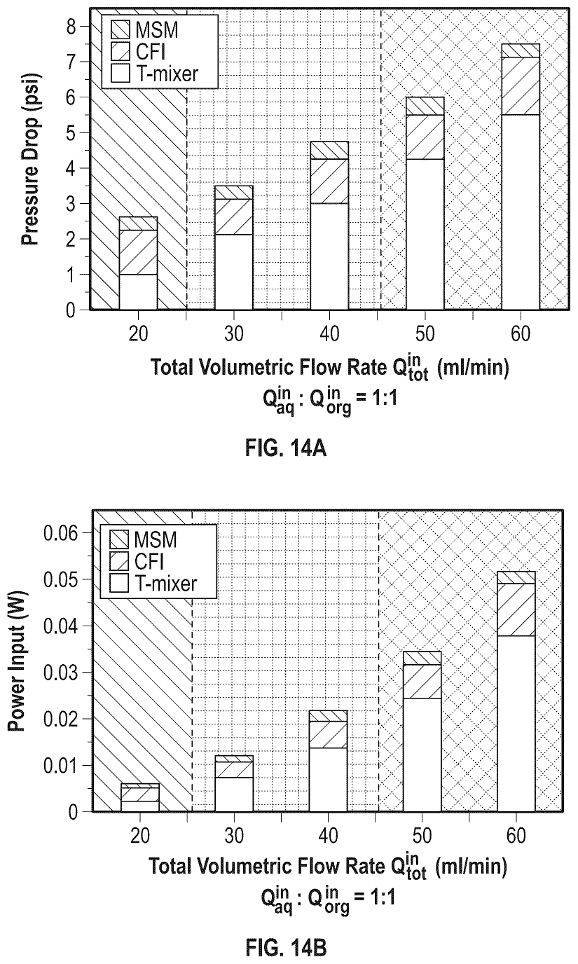

In this flow, inertial and viscous stresses experienced by the brine in the CFI create a substantial deformation of the interface and the subsequent formation of microdroplets. These microdroplets can be as small as 5 μm in diameter, resulting in a considerable increase of the interfacial surface area up to 200,000 m²/m³ and shorter diffusional lengths. Ultimately, this flow regime can increase the mass transfer rates by up to 20-50 times relative to slug regime. While a thorough characterization of these microdroplets' size was outside the scope of this work, it was reported that smaller microdroplets are formed at higher flow rates since more energy is available for phase dispersion in the T-mixer as shown in FIGS. 14A-14B.

### Resulting Extraction Performance

As expected, the extraction efficiency in the T-mixer, expressed as E_{M %} and E_{M/eq %}, generally increased at higher flow rates for all four metals (FIGS. 10 and 11). This can be attributed to the stronger phase mixing and shearing, smaller droplet generation, and higher intensity of internal convective flows at greater flow velocities in the T-mixer. The complete dominance of the inertial forces in the T-mixer relative to the viscous and interfacial forces is reflected by the high We and Reynolds

$$( Re = \frac{ρ vd}{μ} )$$

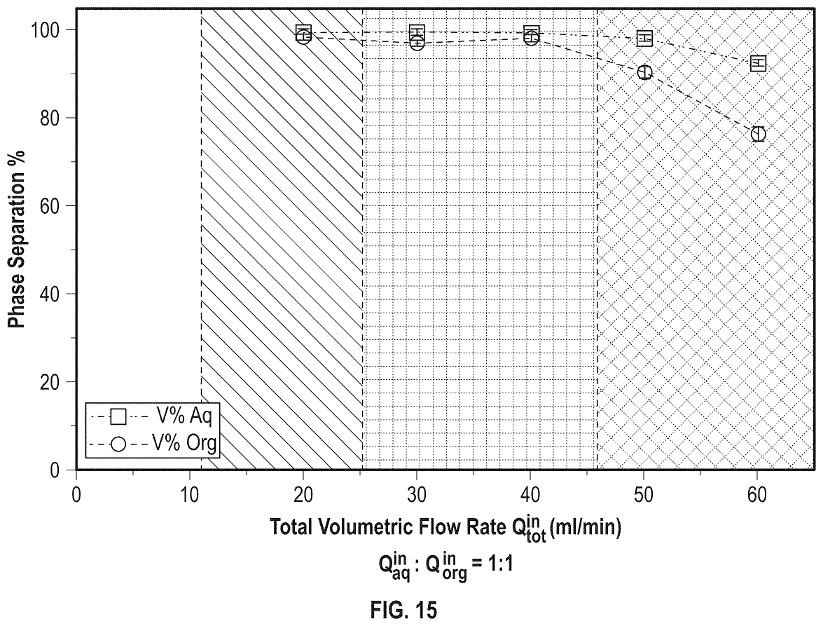

numbers calculated at up to 1507 and 1625 for brine, and 1744 and 2646 for TBP/DS, respectively. At Qₜₒₜⁱⁿ=30 mL/min, limited lithium extraction occurred, with E_{Li/eq %}=18.7% (SD=±2.5%) reached within approximately 0.106 seconds of contact. As Qin, was increased to 60 mL/min, the mass transfer limit was almost attained within only 0.53 seconds, with E_{Li/eq %}=97.2% (SD=±2.85%). These extremely high mass transfer rates were realized by forcing two-phase mixing at elevated flow rates within small geometries (T-mixer ID=0.5 mm). While extremely advantageous from an extraction perspective, this approach incurs phase separation challenges and a substantial increase in pressure drop and power input as shown in FIGS. 14A-14B and 15. On the other hand, the lowest flow rate of Qₜₒₜⁱⁿ=20 mL/min, lithium extraction was higher than expected with E_{Li/eq %}=35.7% (SD=±3.7%). Without being bound to any particular theory, it is currently believed that this effect can be attributed to an experimental artifact related to more uniform pumping and thus synchronized phase shearing in the T-mixer under lower pressure drops.

As for the extraction performance in the CFI, three factors determined its efficiency; the first is the residence time (τₑₓₜ) in the CFI, with longer τₑₓₜ at lower Qₜₒₜⁱⁿ promoting larger mass transfer across the interface. The second is the specific interfacial surface area available for mass transfer directly determined by the two-phase flow patterns in the CFI. As previously described, the microdroplets of the dispersed droplet flow regime result in the highest interfacial area, followed by regular slugs, and lastly the merged irregular slugs. Consequently, it is expected that the highest interfacial surface area in the CFI was achieved at 60 mL/min, then decreased in this order: 50, 20, 30, and 40 mL/min. The third factor is the intensity and velocity of the secondary convective flows critical for cross-sectional mixing and interface regeneration via Dean vortices. At higher flow rates, greater centrifugal forces are created which in turn increase the intensity of these convective flows in the CFI. Consequently, higher mass transfer rates are expected at elevated flow rates, mirrored by an increase in Dean number

$$( ( De = Re \sqrt{\frac{1}{λ}} ) .$$

De number shows the ratio of the inertial and centrifugal forces relative to the viscous force (Table 2). Additionally, higher Dean velocities (V_{De}) can be achieved at greater flow rates, calculated using Equation 23:

$${V}_{De} = 1.8 {\text{.10}}^{- 4} {De}^{1.63} \qquad ( Equation 23 )$$

Under the regular slug regime at Qₜₒₜⁱⁿ=20 mL/min, the extraction of lithium and other metals in the CFI approached mass transfer limits, with E_{Li/eq %}=98.3% (SD=±2.9%), a noticeable increase from the values measured in the T-mixer only. It is expected that the long τₑₓₜ of 75 seconds and a relatively large interfacial surface area contributed to the extraction, despite slower dean vortices V_{De}.

Under the irregular slug regime developed at Qₜₒₜⁱⁿ=30 mL/min, satisfactory extraction levels were also achieved with E_{Li/eq %}=94.2% (SD=+2.8%). It is suspected that despite the drop in Text and interfacial area, the increase in V_{De} advanced the extraction. Conversely, at Qₜₒₜⁱⁿ=40 mL/min, where the largest slugs were formed, a noticeable drop in extraction levels occurred with E_{Li/eq %}=79.5% (SD=±2.7%). At this flow rate, the centrifugal forces could not compensate for the drop in Text and the increase in interfacial area. The limitations on irregular slugs to achieve satisfactory mass transfer for hydrometallurgical feeds in the CFI were also found in previous studies.

As for the dispersed droplet regime at Qₜₒₜ^{it}=50 and 60 mL/min, complete extraction was achieved in the CFI in less than 30 seconds of contact. This can be attributed to the large interfacial area of the microdroplets, coupled with intense centrifugal mixing. Finally, the separation factors β_{Li/Mg}), Na (β_{Li/Mg}), and K (β_{Li/K}) in the CFI also approached the equilibrium values reported in the literature for the same extraction system (FIGS. 12A-12B). On the other hand, extensive fluctuations of this parameter were observed in the T-mixer at lower flow rates, especially for β_{Li/Mg}, but this effect was not further investigated.

### Fundamentals of Phase Separation in the 3D-Printed Phase Separator

The 3D-Printed PETG phase separator achieves a continuous, capillary-based, membrane-free, and gravity-independent phase separation by generating an interfacial capillary pressure (ΔP_{cNet}) that acts on the non-wetting aqueous phase (i.e., synthetic brine), as disclosed herein. This pressure field is developed in each of the 36 sloped channels perpendicularly to the direction of flow (x-dimension), and it is continuously exerted across a channel's length (z-dimension). ΔP_{cNet} directs the aqueous phase towards the wider side of the channel, where it ultimately stratifies and coalesces before exiting via the aqueous outlet. The magnitude of ΔP_{cNet} is the net difference between the two opposing and unequal local interfacial capillary pressures (ΔP_{cA}) and (ΔP_{cB}) applied laterally on both ends of a non-wetting aqueous droplet as shown in FIG. 6, and as previously discussed in relation to Equations 1-6.

FIG. 6 shows the magnitudes of ΔP_{c} generated in the phase separator under TBP/DS and synthetic brine across the available channel depths with σ=12.8 mN/m and 0=72°. ΔP_{c} decreases from 29.9 Pa at the narrowest end of the channel (d=530 μm) to 7.9 Pa at the widest edge (d=2000 μm). An illustration of ΔP_{cNet} exerted on a non-wetting aqueous droplet extending from d_{A}=800 μm to d_{b}=1500 μm is presented as an example. For the sloped channel to exert ΔP_{cNet} critical for separation, the non-wetting droplet must have a diameter larger than 530 μm, corresponding to a minimum volume of 77.95 nL. It can also be noticed that

$$\frac{\partial Δ {P}_{c}}{\partial d}$$

increases with decreasing channel depths. This favorable effect imposes an increased resistance on the non-wetting aqueous phase as it approaches the narrower side of the channel where the organic outlet is located.

Similar to other capillary-based micro-separators, the separation performance in the phase separator is not solely governed by interfacial forces. The interactions of the interfacial, inertial, viscous, and to a lesser extent gravitational forces, create the force landscape in the spacetime domain that dictates the phase separator's functionality. While a Computational Fluid Dynamics (CFD) mathematical model, such as the COMSOL model used in this example, is warranted to capture the local dynamic forces exerted on the two-phase interface in the phase separator, the overall effects of those fluidic forces on separation can be outlined. The hydrodynamic pressure drop (ΔP_{hyd}) is a dependent variable relating geometric dimensions, total flow rate (Qₜₒₜⁱⁿ), and dynamic viscosity (μ), thus combining inertial and viscous terms. Consequently, the relative magnitudes of ΔP_{hyd} and ΔP_{c} at a given orifice is a reliable predictor of separation performance used to assess previous micro-separators. A sudden separation failure, reflected by a breakthrough of the non-wetting phase across an opening, was expected when ΔP_{hyd} exceeded the co-linear opposing ΔP_{c} in these systems. In the phase separator, however, the direction of ΔP_{hyd} (z-dimension) is perpendicular and not co-linear to ΔP_{cNet} (x-dimension) FIG. 6. Consequently, even when ΔP_{hyd}>ΔP_{cNet}, the lateral movement of a non-wetting droplet towards the wider edge of the channel can be partially retained. For a non-wetting droplet located at the narrowest side of the channel's entrance, the relative ratios of ΔP_{hyd} to ΔP_{cNet} should be such that, the time needed for the droplet to reach the aqueous outlet (τₛₑₚ) is smaller or equal to the residence time of the droplet in the channel (τᵣₑₛ). Consequently, for this simple illustrative case, three different scenarios can be identified:
Case 1: ΔP_{hyd}<<<ΔP_{cNet}: Successful separation, τₛₑₚ<<<τᵣₑₛ, with droplet trajectory≈width of the sloped channel (14.60 mm).
Case 2: ΔP_{hyd}>>>ΔP_{cNet}: No separation, τₛₑₚ>>>τᵣₑₛ, with droplet trajectory≈length of the sloped channel (55.7 mm).
Case 3: Comparable ΔP_{hyd} and ΔP_{cNet}: Successful separation provided that τₛₑₚ≤τᵣₑₛ.

Therefore, for a fixed sloped channel geometry, the separation performance can be improved by operating under higher interfacial tensions (σ) and reduced wetting angles (θ), leading to greater interfacial forces ΔP_{cNet} (Eq. 3-22). Conversely, the separation efficiency can be expected to drop with increasing flow rates (Qₜₒₜⁱⁿ) and fluids viscosities (μ), translating to higher ratios of inertial and viscous forces relative to interfacial forces (ΔP_{hyd}/ΔP_{cNet}). It is to be appreciated that operating with highly viscous fluids such as synthetic brine (μ_{Brine}=5.2 cP) and TBP/DS (μ_{TBP/DS}=3.08 cP) is expected to augment the viscous drag acting on the lateral movement of the non-wetting phase. This in turn results in detrimental effects on separation.

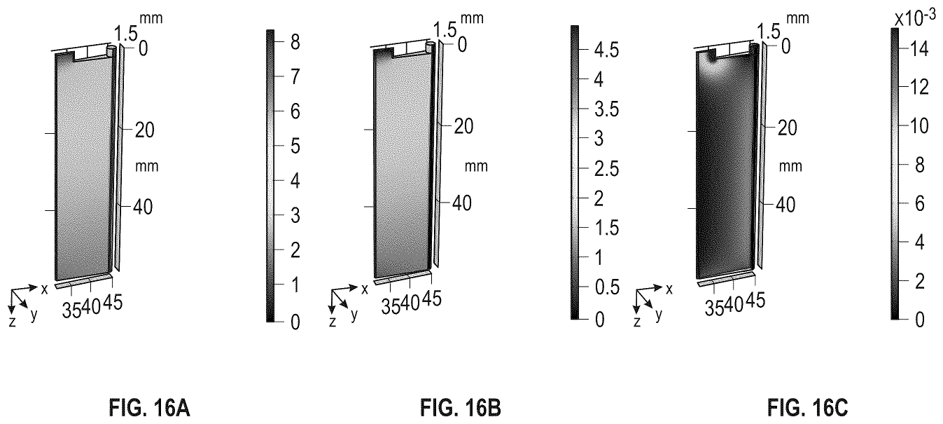

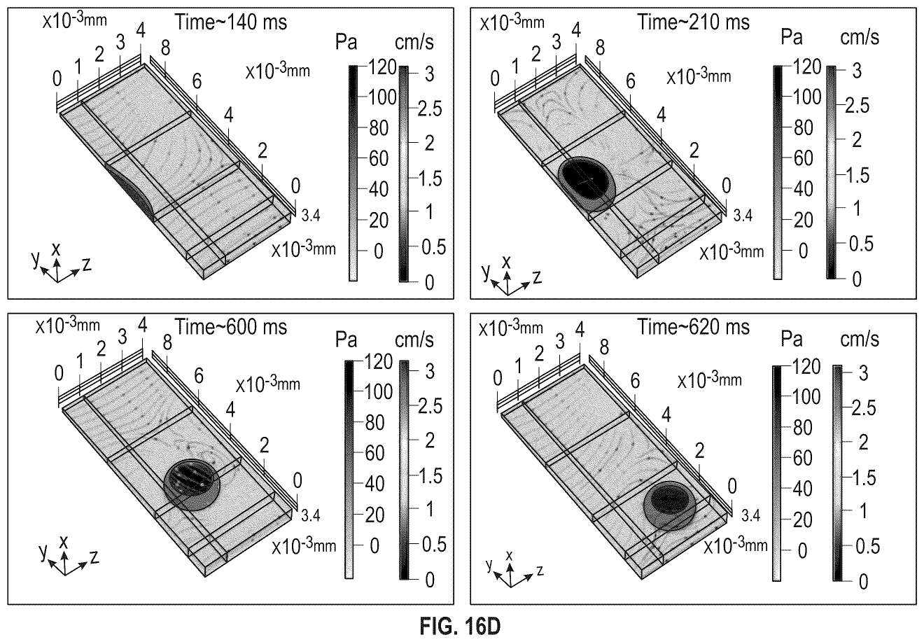

3D COMSOL models were developed to obtain reliable ΔP_{hyd} and velocity estimates in a phase separator sloped channel for both the wetting TBP/DS and the non-wetting brine (FIGS. 16A-16D). These single-phase models reflect the highest pressures and velocities expected in the experimental runs at Qₜₒₜⁱⁿ=60 mL/min/MMS. ΔP_{hyd} values of 4.5 and 8.5 Pa were found for TBP/DS and brine, respectively. Hence, the actual two-phase system is expected to have ΔP_{hyd} values ranging between these limits depending on phase composition in the channel. Comparing the minimum and maximum ΔP_{hyd} values to ΔP_{cNet}, it can be deduced that ΔP_{cNet} values greater than ΔP_{hyd} can be generated in the phase separator even under these unfavorable separation conditions. The maximization of ΔP_{cNet} can be particularly achieved under large droplets with high ΔP_{cA} and ΔP_{cB} differential, and smaller channel depths.

Finally, by placing the phase separator in a vertical position, the gravitational forces will be exerted perpendicularly to ΔP_{cNet}. Therefore, the impact of gravity on the lateral two-phase separation (x-dimension) is negligible. The gravitational effect will be limited to its influence on fluid velocities in the z-dimension due to buoyancy.

FIG. 6 shows the movement of the non-wetting droplet towards the wider side of the sloped channel at different time intervals. The pressure and velocity profiles within the flow geometry are also shown.

### Phase Separation in the 3D-Printed Phase Separator

The phase separation of synthetic brine and TBP/DS was assessed in the phase separator after connecting it vertically to the micromixer-CFI extraction system. The tests were carried out under total volumetric flow rates (Qₜₒₜⁱⁿ) of 20, 30, 40, 50, and 60 mL/min. The inlet aqueous: organic volumetric flow ratio (Q_{aq}ⁱⁿ:Q_{org}ⁱⁿ) was set to 1:1, and the outlet flow rates from the phase separator's exit ports were equal (Q_{aq}^{out}:Q_{org}^{out}=1:1). The PETG surface of the 3D-Printed phase separator was inherently wetted by the organic solvent TBP/DS. FIG. 15 shows the volume purities of samples collected at the organic (V %_{org}) and aqueous (V %_{aq}) outlet ports under 1 min of steady operation. At Qₜₒₜⁱⁿ of 20, 30, and 40 mL/min, regular or irregular slug regimes dominated in the CFI, and near-total phase separation was achieved, with an average V %_{org}=98.0% (SD=±0.7%) and V %_{aq}=99.6% (SD=±0.1%). As Qin was increased to 50 and 60 mL/min, the highly efficient dispersed droplet pattern appeared in the CFI, accompanied by a decline in the phase separator's separation performance. While the separation remained satisfactory at Qₜₒₜⁱⁿ=50 mL/min with V %_{org}=90.5% (SD=±1.3%) and V %_{aq}=98.3% (SD=±0.6%), it extensively deteriorated at Qₜₒₜⁱⁿ=60 mL/min, especially at the organic outlet, with V %_{org}=76.5% (SD=±1.4%) and V %_{aq}=92.5% (SD=±0.6%).

These results show that despite the unfavorable separation conditions of high viscosity (μ_{Brine}=5.2 cP, μ_{TBP/DS}=3.08 cP), limited interfacial tension (σ=12.8 mN/m), and high wetting angle (θ=72°), satisfactory phase separation can be achieved in the phase separator up to 50 mL/min. Additionally, separating the highly-efficient dispersed droplet flow regime at high throughputs without the need for a coalescer is a distinctive ability of the phase separator.

These operational capabilities can be ascribed to MMS' design, which allows the parallel operation of 36 sloped channels, and the successful distribution of the two-phase flow amongst them. Consequently, effective interfacial capillary pressures (ΔP_{cNet}) can be generated in each channel, permitting both separation intensification on an individual level and a scale-up of throughput on a collective level. The excellent separation observed up to 40 mL/min indicates that the non-wetting brine was completely directed toward the deeper edge of the sloped channel by ΔP_{cNet}, and in the process displacing TBP/DS to the narrower side.

As expected, and similar to other micro-separators, operating under slug-dominated regimes did not present major separation challenges, owing to the slugs' large size relative to dispersed droplets and their fast coalescence. Additionally, these favorable experimental results, coupled with COMSOL's pressure drop estimates (FIGS. 6 and 16A-16D), suggest that ΔP_{hyd} was sufficiently low relative to ΔP_{cNet} to ensure complete phase separation, satisfying the τₛₑₚ≤τᵣₑₛ condition. Conversely, an expected drop in separation performance was seen under the efficient yet hard-to-separate dispersed droplet regime at Qₜₒₜⁱⁿ of 50 and 60 mL/min. It was interesting to observe that the purity of the outlet flow at the aqueous exit port (V %_{aq}) remained relatively high, while it was disproportionally lower at the organic port (V %_{org}). This discrepancy happened despite forcing the outlet flow rates from the aqueous and organic ports to be equal. These high levels of V %_{aq} strongly suggest that the ΔP_{cNet} pressures generated by the sloped channels served their purpose of forcing the aqueous brine towards the wider end of the channels and ultimately to the aqueous outlet.

This conclusion is further supported by the complete absence of brine droplets in the outlet streams at 50 and 60 mL/min, possibly indicating that most of the aqueous parcels in the phase separator sufficiently coalesced to exceed the critical diameter of 530 μm required for ΔP_{cNet} generation. Furthermore, the magnitude of ΔP_{cNet} relative to ΔP_{hyd} remained considerable enough to induce phase separation even at 60 mL/min. As for the low V %_{org} values, they can be directly attributed to the large ΔP_{hyd} pressures exerted by the highly viscous brine at elevated flow rates near the organic exit port. These significant ΔP_{hyd} pressures overcome the repelling ΔP_{cNet} generated by the less viscous TBP/DS, leading the aqueous brine to break through the organic outlet along TBP/DS. Similar behavior has been repeatedly observed in previous micro-separators.

The velocity profile in the sloped channel predicted by the COMSOL 3D model at 60 mL/min captures this performance deterioration near the organic outlet. The sharp velocity increase near that narrow port promotes the surge of ΔP_{hyd} responsible for the brine's breakthrough. This effect can occur regardless of the satisfactory separation happening in previous parts of the sloped channel. Furthermore, it is expected that this preferential exit of the aqueous brine from the outlets will ultimately induce an accumulation of the organic phase in the device based on mass balance considerations. Consequently, it is projected that after this build-up reaches a certain critical point, the wetting organic phase will be forced to exit unhindered through the exit ports, possibly bringing the phase purities at both outlets to similar levels. This “build-up” and “release” may amount to a periodic cycle, and a deeper investigation of this behavior is warranted. Finally, based on the findings above, it is expected that repositioning the outlets to the channel's sides can improve separation by decreasing the velocity gradients near the exit region. Additionally, a post-printing surface treatment of the polymer to increase its hydrophilicity and/or hydrophobicity can allow for higher throughput processing by increasing the magnitude of ΔP_{cNet}.

### Pressure Drop and Power Input

The pressure drop (ΔP) in the test-loop was measured across the investigated Qin, for the T-mixer only, then after connecting the CFI, and finally the phase separator. Subsequently, the Power Input (Pᵢ) was calculated according to (Equation 19), as discussed herein. FIGS. 14A-14B show the measured ΔP and Pᵢ values at different flow rates in the test-loop. As expected, a substantial increase in ΔP and Pᵢ were found at higher throughput levels. At Qₜₒₜⁱⁿ=20 mL/min, ΔP and Pᵢ values of 2.6 psi and 0.006 W were found. Conversely, at Qₜₒₜⁱⁿ=60 mL/min, these numbers increase significantly to 7.5 psi and 0.52 W. The T-mixer was the component that contributed most to both parameters, especially at elevated flow rates, owing to its substantially smaller flow geometry. The CFI was the second largest, followed by the phase separator. Thus, it is evident that the extraction part of the test-loop (i.e., T-mixer+CFI) induced the highest-pressure build-up and power consumption, reaching up to 95% of the total at Qₜₒₜⁱⁿ=60 mL/min.

These findings are consistent with the highly viscous nature of hydrometallurgical feeds which necessitates extensive energy input to achieve adequate phase shearing and mixing. Additionally, extraction in viscous environments is particularly challenging given the reduction of diffusion coefficients and internal convective flows' velocities at these conditions. On the other hand, the pressure drops in the CFI measured here are consistent with literature values. These values remain orders of magnitude lower than in other high-throughput systems such as the re-entrance flow microreactor and conventional extractors. Furthermore, it is expected that operating the T-mixer-CFI-phase separator system for other extraction applications with lower fluid viscosities will lead to lower pressure drops and power consumption.

Finally, by holistically considering the results reported in this work, i.e.: the two-phase flow patterns and their ramifications on extraction in FIGS. 11A-11B and 13, the two-phase separation in the phase separator in FIG. 15, and the power requirements in FIGS. 14A-14B, a trade-off pattern emerges. Thus, three characteristically different process operation regimes can be identified which are in function of flow rate:
Regime 1 at Qₜₒₜⁱⁿ=20 mL/min under regular slug flow pattern:
   Advantages: High extraction, High separation, lower power consumption
   Disadvantages: Low throughput
Regime 2 at Qₜₒₜⁱⁿ=50-60 mL/min under dispersed droplet flow pattern:
   Advantages: High extraction, High throughput
   Disadvantages: Higher power consumption, incomplete separation
Regime 3 at Qₜₒₜⁱⁿ=30-40 mL/min under flow pattern: considered as a trade-off regime.

The determination of the adequate regime of operation is contingent on the OPEX and CapEX assessment of the system. However, it is worth noting that to process 30 m³ of brine per day, 834 T-mix-CFI-phase separator units must be numbered-up and operated individually at 50 mL/min. With Pᵢ=0.34 W per unit, and assuming 0.12 U.S. Dollar per kWh, the pumping energy cost per year for these 834 units would amount to only $29.81.

This example discloses the design and test results of a 3D-printed, recyclable, and low-cost phase separator for high-throughput lithium extraction intensification. The device achieved capillary-driven, membrane-free, and gravity-independent separation in its 36× scaled-up sloped channels. This example additionally assessed lithium extraction in Coiled-Flow Inverter (CFI) at unprecedentedly high throughputs for this application. The two-phase flow patterns in the CFI had major effects on extraction and separation performance. Three flow regimes were identified: regular slug, irregular slug, and dispersed droplet. Both the regular slug and dispersed droplet flows reached mass transfer extraction limits. Satisfactory separation was achieved across the investigated flow rates, except at the highest flow rate of 60 mL/min. The deterioration was attributed to sharp velocity changes near the outlets. The pressure drops and power inputs of the test-loop's components were measured, and the T-mixer was found to offer the highest resistance to flow. Three regimes of operation were identified which were tied to the developed flow patterns.

### Example 2: Isopropanol Extraction

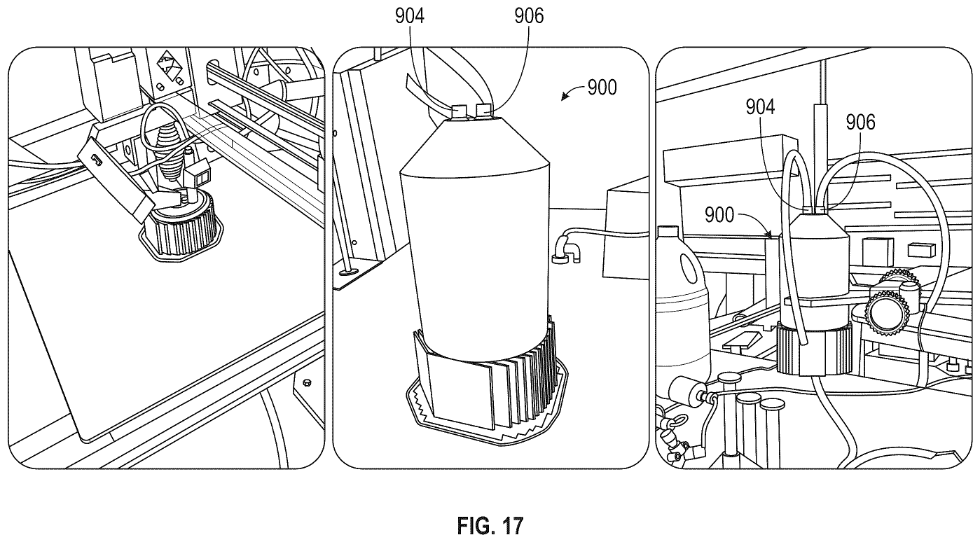

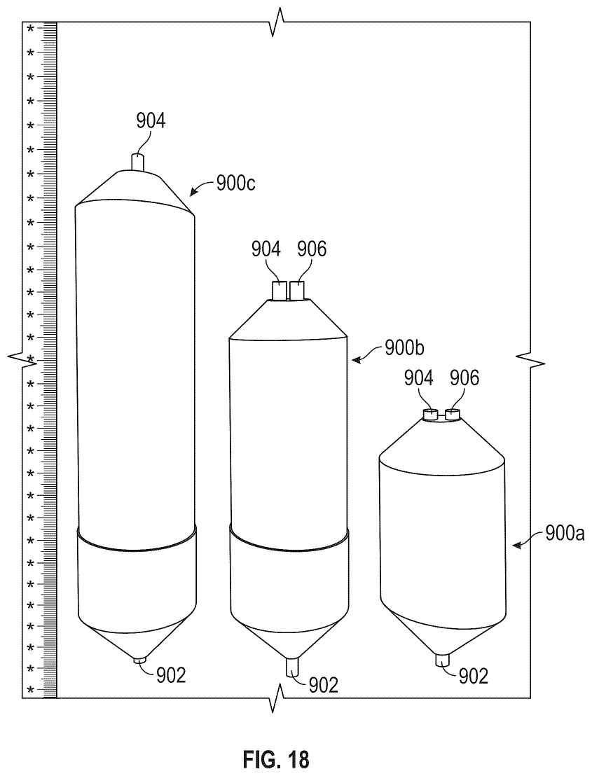

An additively manufactured separator design, referred to herein as MMS-X 900 (designed substantially similar to separators described herein, such as separator 200), was developed and built from polylactic acid (PLA) polymer using a Prusa i3 3D printer, as shown in FIG. 17. The MMS-X 900 design comprised 36 rotated slope plates, fit together inside a cylindrical monolith. Three example devices 900a, 900b, 900c were prepared, as shown in FIG. 18. The slope plates had one common inlet port 902 and two outlet ports 904, 906 for separated organic and aqueous output fluids. The smallest size device 900a had a height of approximately 12 cm and a diameter of approximately 5 cm with a total internal volume of approximately 30 mL. The MMS-X 900 separators were configured to be attached to T-mixers of various designs, had a low manufacturing unit price, and were able to be built from different chemically resistant polymers/metals, as described herein. Additionally, the MMS-X 900 separator used in the present example did not require any form of internal sealing, offered “plug-and-play” capability, and exhibited high operational redundancy.

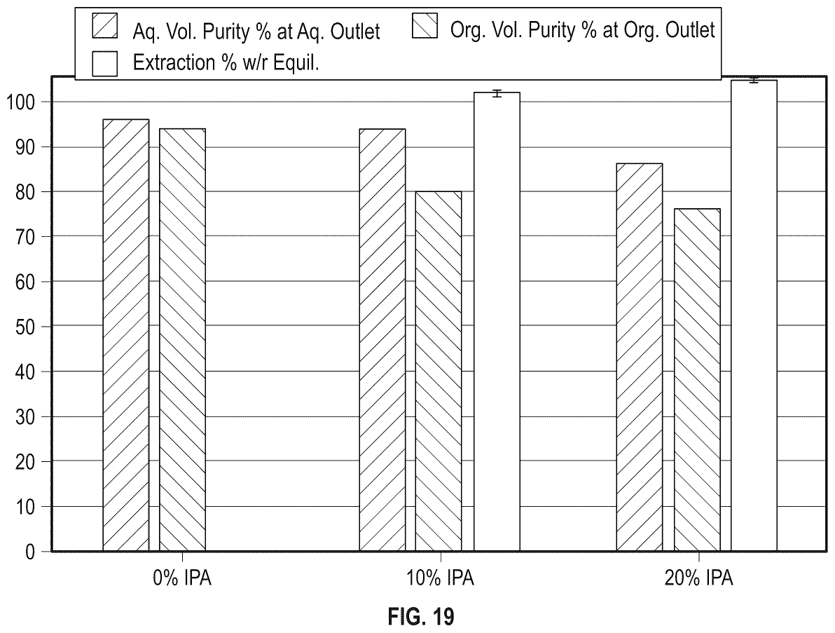

The extraction and phase separation of the device was tested without any surface treatment, such as a hydrophobic coating, a hydrophilic coating, or a catalyst (that is, the testing was performed on pristine PLA polymer) using Isobutanol-Cyclohexane-Water and Isopropanol (IPA)-Ethyl Hexanoate-Water ternary fluid mixtures. The tests yielded high phase purity results, in some cases exceeding 90%, with a throughput of 160 mL/min, as shown in FIG. 19. The solvent extraction and phase separation of aqueous IPA were assessed in the MMS-X 900 device at a constant flow rate of 150 mL/min and constant O:A inlet ratio of 1:1. The tested aqueous IPA concentrations were 0%, 10% and 20%, measured as w/w. In the extraction process performed ethyl hexanoate identified as the wetting phase.

The mixing of phases was achieved in an externally attached T-mixer with ID=1 mm. Despite the relatively large channel size of the T-mixer, it was anticipated that the mass transfer achieved via the intense mixing experienced at high flow rates would lead to high extraction performance. FIG. 19 shows the extraction and phase separation performance of the smallest size MMS-X 900 under these investigated parameters. Across all the tested conditions, volume purities of greater than 75% were achieved (lowest at 20% w/w IPA). The highest organic and aqueous purity levels were 94% and 96% respectively at 0% w/w IPA. Without being bound to any particular theory, the reduction in separation performance under higher concentrations of IPA is believed to result from the diminishing interfacial tension for the generation of capillary pressures that is observed in the presence of IPA.

While these results were obtained at a flow rate of 150 mL/min and with no surface treatment applied to the polymer, it is expected that separation performance would be improved by using a surface treatment of the surface (that is, with one or more of a hydrophobic coating, a hydrophilic coating, or a catalyst). It is also expected that and using the “taller” devices would further increase the total the separation performance, by giving the mixture additional time and distance to separate.

Higher phase purity results were observed for the Isobutanol-Cylohexane-Water system, which, without being bound to any particular theory, is believed to be the result of the higher interfacial surface tension of cyclohexane-water. It was also observed that a total extraction of IPA was achieved in the MMS-X 900 device for 10% and 20% w/w IPA concentrations. This total extraction of the solute was achieved despite using a relatively large inner dimeter T-mixer (ID=1 mm). Without being bound to any particular theory, it is believed that the high mixing intensity achieved at the high flow rate of 150 mL/min significantly enhanced the mass transfer rate despite the diffusional limitations that arise from using larger microchannels. This was attributed to the development of the highly efficient “dispersed flow” extraction regime. It is furthermore believed that in a high mixing environment, internal and external convective flows can regenerate the interface surface and create smaller dispersed organic droplets; two factors which may accelerate mass transfer. These results highlight the advantages of achieving extraction at high flow rate regimes, leading to rapid and in some cases complete extraction, despite an expected increase of pumping energy requirement.

### Example 3:100 Hour Isopropanol Separation

Longevity testing on the MMS-X 900 of Example 2 was performed under 100 hours of continuous operation. The aqueous feed was an industrial waste solution, primarily containing Isopropanol (IPA) along other constituents (see Table 3). The aqueous feed contains several unidentified chemical compounds since the origin of the feed is in an industrial process. One purpose of the 100-hour test was to confirm if these collateral trace compounds may influence, harm, or diminish the operation efficiency of the MMS-X device.

TABLE 3
Industrial Waste Aqueous Feed Composition.

| | |
|---|---|
| Water | 85% |
| 4-methyl-2-pentanol | 0.87% |
| Isobutanol | 0.02% |
| Isopropanol | 14.2% |

Phase separation in the MMS-X 900 device was assessed over the course of a 100 hour test, using the industrial waste feed with a cyclohexane system for the extraction of IPA. The immediate objective of this test was to validate the performance stability and surface integrity of the MMS-X 900 device after prolonged exposure to the unfiltered waste feed and solvent. This was done by monitoring the effects of these factors on phase separation at the beginning of the run (at t=0) and subsequently at 20 hours intervals.

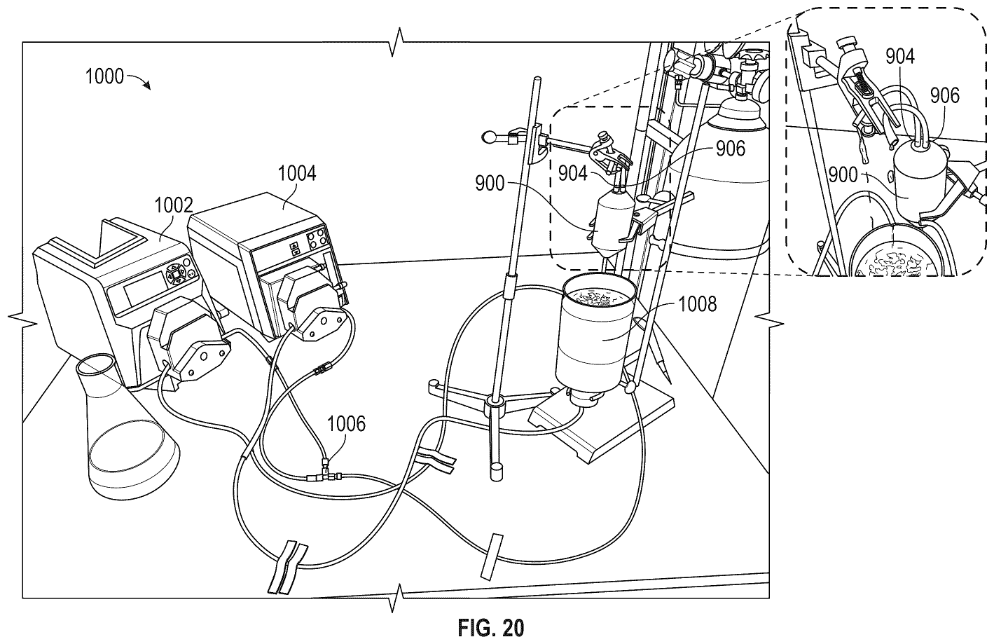

The test-loop 1000, show in FIG. 20, utilized two Masterflex® peristaltic pumps 1002, 1004, each capable of delivering flow rates between 8 and 480 mL/min. The pumps 1002, 1004 delivered the aqueous and organic solutions to a PEEK T-mixer 1006 (ID=1 mm), ensuring phase mixing under slug-dominated regime. Subsequently, the two-phase mixture was passed through a Tefzel® extraction channel (L=75 cm, ID=1.588 mm, OD=3.175 mm) leading to the 3D-printed MMS-X 900 unit. The separation unit was printed using PETG via a Prusa i3 MK3S+ 3D printer.

After achieving two-phase separation in MMS-X 900, the aqueous and organic effluents were directed out of the separator to a large settling unit 1008 via fixed Tygon® tubes (L=10 cm, ID=2.791 mm, OD-4.519 mm). After achieving gravity separation in the settling unit 1008, the fluids were re-introduced to the pumps 1002, 1004. This closed system allowed reduction in the chemical usage, improved safety, and limited the environmental impact of the experiment, while minimally affecting the experimental fidelity.

The total flow rate was set to 40 mL/min, with an O:A inlet ratio of 1:1. The outlet tubes' heights and profiles were fixed, leading to an O:A outlet ratio approaching 1:1. The industrial waste feed and cyclohexane were pre-equilibrated before the start of the experiment by mixing the phases for 10 minutes to reach mass transfer limits. This allowed elimination of the variability in interfacial tension observed during alcohol mass transfer from one phase to another, and the accompanying change of phase volumes during that process. This helps to ensure that the only variables impacting surface separation are the ones identified as of topic of interest (i.e. MMS-X 900 surface integrity/fouling and platform stability). Finally, given the major loss of cyclohexane throughout the testing period (predominantly to evaporation), new volumes of pre-equilibrated aqueous and organic phases were introduced in the test-loop on regular basis, with an approximate rate of 300 mL per phase every 24 hours.

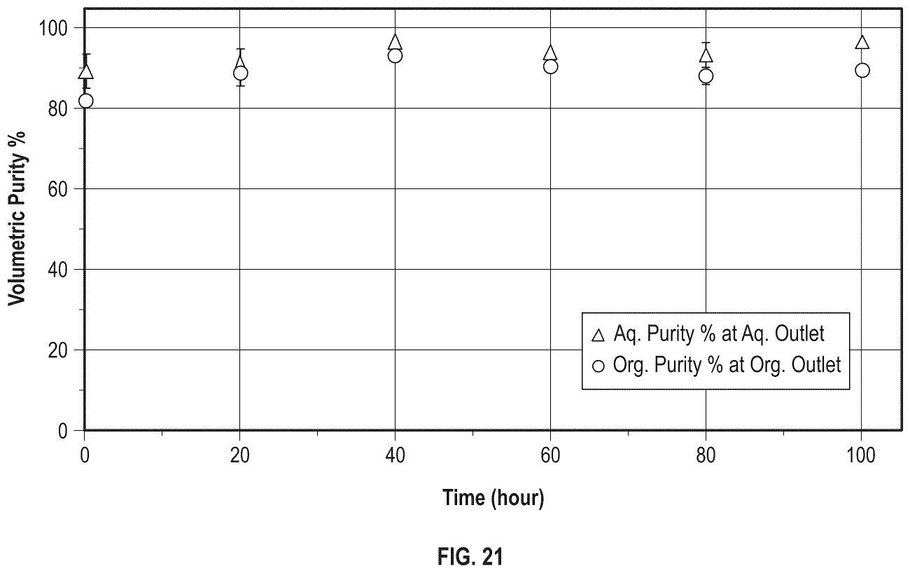

FIG. 21 shows the phase purity of the samples obtained from the aqueous and organic effluents throughout the 100-hour duration of the experiment. The samples were collected for 1 minute from both outlets in triplicates. It was observed that both the aqueous and organic phase separation purity at their respective outlets were consistently high and stable throughout the 100 hours, respectively averaging at 93.5% (SD±2.9) and 88.7% (SD±3.7).

The high and stable phase separation performance in the MMS-X 900 device strongly indicates that the long-term surface exposure to both the waste industrial feed and organic solvent did not lead to noticeable change in surface properties, translating in stable operational performance. As shown in our previous experimental studies, an adequate outlet flow control is critical for a successful MMS-X 900 device operation. It can therefore be deduced that fixing the outlet flow pressure via fixing the tube height can lead to highly stable device performance. These results demonstrate the capacity of separator devices described herein for long-term and stable processing of industrial feeds.

In view of the many possible embodiments to which the principles of the present disclosure may be applied, it should be recognized that the illustrated embodiments are only preferred examples of the disclosure and should not be taken as limiting the scope of the present disclosure. Rather, the scope is defined by the following claims. We therefore claim as our invention all that comes within the scope and spirit of these claims.

We claim:

1. A fluid phase separator, comprising:
one or more capillary cells, each capillary cell comprising a first plate, a corresponding second plate spaced apart from the first plate, and a gap between the first plate and the second plate;
an inlet in fluid communication with a first end of the one or more capillary cells;
a first outlet in fluid communication with a second end of the one or more capillary cells; and
a second outlet in fluid communication with the second end of the one or more capillary cells,
wherein each first plate is disposed at an angle to the corresponding second plate, such that a distance between each first plate and the corresponding second plate is greater at a first side of each capillary cell than at a second side of each capillary cell, and
wherein the fluid phase separator is configured to (i) admit a first mixture of at least a first fluid and a second fluid at a first concentration, (ii) split the first mixture into a second mixture of the first fluid and the second fluid at a second concentration and a third mixture of the first fluid and the second fluid at a third concentration, and (iii) emit the second mixture and the third mixture from the first outlet and the second outlet respectively.

2. The fluid phase separator of claim 1, wherein the one or more capillary cells are in communication with the inlet at the first end of the one or more capillary cells and also in communication with the first outlet and the second outlet at the second end of the one or more capillary cells.

3. The fluid phase separator of claim 2, comprising a plurality of the one or more capillary cells and wherein capillary cells of the plurality are arranged in a cylindrical configuration, spaced circumferentially apart from one another such that the first side of each capillary cell is positioned towards a periphery of the cylindrical configuration and the second side of each capillary cell is positioned towards a center of the cylindrical configuration.

4. The fluid phase separator of claim 3, further comprising a first collector positioned between the second end of the plurality of the one or more capillary cells and the first outlet.

5. The fluid phase separator of claim 4, further comprising a second collector disposed radially outwards from the first collector and positioned between the second end of the plurality of the one or more capillary cells and the second outlet.

6. The fluid phase separator of claim 1, wherein a surface of the first plate and/or a surface of the second plate is at least partially covered with a hydrophilic coating or a hydrophobic coating.

7. The fluid phase separator of claim 6, wherein the hydrophilic coating is applied in a gradient, such that a first lateral portion of the first plate and/or the second plate has a higher hydrophilicity than a second lateral portion of the first plate and/or the second plate, or the hydrophobic coating is applied in a gradient such that a first lateral portion of the first plate and/or the second plate has a higher hydrophobicity than a second lateral portion of the first plate and/or the second plate.

8. The fluid phase separator of claim 1, wherein the distance between the first plate and the second plate at the first side of the capillary cell is a factor in a range of 1.2 to 50 greater than the distance between the first plate and the second plate at the second side of the capillary cell.

9. The fluid phase separator of claim 1, wherein the distance between the first plate and the second plate at the first side of the capillary cell is a factor in a range of 1.8 to 50 greater than the distance between the first plate and the second plate at the second side of the capillary cell.

10. The fluid phase separator of claim 1, wherein the distance between the first plate and the second plate at the first side of the capillary cell is 2 mm or less.

11. The fluid phase separator of claim 1, wherein the first plate is disposed at an angle relative to the second plate that ranges from 0.5° to 20°.

12. The fluid phase separator of claim 1, wherein the fluid phase separator does not comprise a membrane or a filter.

13. A method of separating two or more fluid phases, comprising:
introducing a mixture comprising two or more fluid phases to the fluid phase separator of claim 1;
passing the mixture through a capillary cell of the fluid phase separator with a narrow side portion and a wide side portion and providing a variable angle of contact with a fluid;
separating a first fluid phase of the two or more fluid phases having the highest contact angle with the capillary cell towards the wide side portion of the capillary cell by capillary motion;
separating the fluid phases with lower contact angles with the capillary cell than the first fluid phase towards the narrow side portion of the capillary cell;
collecting the first fluid phase; and
collecting the remaining fluid phases separately from the first fluid phase.

14. The method of claim 13, wherein the first fluid is an aqueous phase and the second fluid is an organic phase.

15. The method of claim 13, wherein the first fluid comprises an extractant and a metallic element, and wherein the second fluid comprises a diluent.

16. The method of claim 13, wherein the mixture is passed through the capillary cell without assistance of gravity.

17. The method of claim 13, wherein the mixture comprises a lithium brine, and wherein the method further comprises contacting the brine with an extractant in a coiled flow inverter.

18. An array of phase separators, comprising the fluid phase separator of claim 1.

19. An array of phase separators, comprising:
a first phase separator, comprising a flow plate, a cover plate, a first inlet, a first outlet, and a second outlet, and an array of columns formed on the flow plate and disposed between the first inlet and the first outlet and the second outlet; and
a second phase separator in fluid communication with the first phase separator, comprising a second inlet, a third outlet, a fourth outlet, and an array of capillary cells circumferentially arranged around a centerline axis and positioned between the second inlet and the third and fourth outlets;
wherein each capillary cell of the second phase separator comprises a first interior surface, a second interior surface oriented at an angle relative to the first interior surface, and a gap positioned between the first interior surface and the second interior surface,
wherein the first phase separator is configured to receive a first fluid mixture with a first composition and produce a first product stream with a second composition and a second product stream with a third composition, and
wherein the second phase separator is configured to receive a second fluid mixture with a fourth composition and produce third product stream with a fifth composition and a fourth product stream with a sixth composition.

20. The array of phase separators of claim 19, wherein the first phase separator is positioned upstream of the second phase separator.

21. The array of phase separators of claim 19, wherein the second phase separator is positioned upstream of the first phase separator.

22. A fluid phase separator comprising:
a cylindrical body having an external wall, an inlet end, an outlet end, a central column extending between the inlet end and the outlet end along a longitudinal axis, and an internal cavity defined by the external wall and the central column;
a plurality of vanes circumferentially disposed around the central column, extending between the inlet end and the outlet end, and extending from the central column to an interior surface of the external wall;
a fluid inlet positioned at the inlet end; and
a first fluid outlet and a second fluid outlet positioned at the outlet end of the cylindrical body;
wherein the plurality of vanes divides the internal cavity into a radially and axially extending plurality of capillary cells, and
wherein the plurality of capillary cells is configured to at least partially separate a mixture of two or more fluid phases.

23. The fluid phase separator of claim 22, further comprising a first collector aligned with the central column and positioned between the plurality of capillary cells and the first fluid outlet, wherein the first collector is configured to receive a first product stream from the capillary cells and convey the first product stream to the first fluid outlet.

24. The fluid phase separator of claim 23, further comprising a second collector positioned radially outwards from the first collector and positioned between the plurality of capillary cells and the second fluid outlet, wherein the second collector is configured to receive a second product stream from the capillary cells and convey the second product stream to the second fluid outlet.

25. The fluid phase separator of claim 22, further comprising a hydrophilic coating, a hydrophobic coating, or any combination thereof disposed on one or more vanes of the plurality of vanes.
